(19) United States
(12) Patent Application Publication
(10) Pub. No.: US 2022/0352512 A1
(43) Pub. Date: Nov. 3, 2022

(54) SLURRY COMPOSITION, ELECTRODE, MANUFACTURING METHOD OF ELECTRODE, SECONDARY BATTERY, BATTERY PACK, AND VEHICLE

(71) Applicant: KABUSHIKI KAISHA TOSHIBA, Tokyo (JP)

(72) Inventors: Tomoe KUSAMA, Tokyo (JP); Kazuomi Yoshima, Yokohama Kanagawa (JP); Tetsuya Sasakawa, Yokohama Kanagawa (JP); Yasuhiro Harada, Isehara Kanagawa (JP); Norio Takami, Yokohama Kanagawa (JP)

(73) Assignee: KABUSHIKI KAISHA TOSHIBA, Tokyo (JP)

(21) Appl. No.: 17/679,005

(22) Filed: Feb. 23, 2022

(30) Foreign Application Priority Data
Apr. 28, 2021 (JP) 2021-076434

(51) Int. Cl. H01M 4/525; H01M 4/485; H01M 4/04; H01M 4/62

(52) U.S. Cl. CPC H01M 4/525; H01M 4/485; H01M 4/0404; H01M 4/0471; H01M 4/625; H01M 2220/20; H01M 2004/021

(57) ABSTRACT

According to one embodiment, a slurry composition includes an active material, a conductive agent, a resin material, and a solvent comprising water. The active material includes niobium titanium-containing composite oxide particles. In a volume-based cumulative frequency distribution of particle sizes based on a particle size distribution of the slurry composition according to a laser diffraction-scattering method, a peak is positioned within a range of 0.8 μm to 3 μm, and a percentage of cumulative frequency up to a particle size of 1 μm from a smaller particle size is in a range of 20% to 35%.

### CROSS-REFERENCE TO RELATED APPLICATIONS

This application is based upon and claims the benefit of priority from Japanese Patent Application No. 2021-076434, filed Apr. 28, 2021, the entire contents of which are incorporated herein by reference.

### FIELD

Embodiments described herein relate generally to a slurry composition, an electrode, a manufacturing method of an electrode, a secondary battery, a battery pack, and a vehicle.

### BACKGROUND

Use of an electrode that includes a niobium titanium oxide as a negative electrode active material in a secondary battery has been considered. Such an electrode is produced by, for example, applying a slurry that includes niobium titanium oxide particles, a conductive agent, and a binder onto a current collector, drying the slurry, and pressing the resultant. If the dispersion strength is insufficient when preparing the slurry, agglomeration of the material components causes an increase in the resistance or a decrease in the capacity. Increasing the dispersion strength when preparing the slurry in order to avoid these incidents causes cracking of the niobium titanium oxide particles, a decrease in the crystallinity of the particle surface, and breakage of the conductive agent such as disconnection of carbon black.

As a result, the resistance of the electrode increases, and the capacity of the battery decreases.

Optimization of the dispersion state of the slurry that includes niobium titanium oxide particles is demanded.

### BRIEF DESCRIPTION OF THE DRAWINGS

FIG. 1 is a diagram showing volume-based cumulative frequency distributions of particle sizes based on particle size distributions of slurry compositions of an example and a comparative example according to a laser diffraction-scattering method.

FIG. 2 is a partially cut-out cross-sectional view of a secondary battery according to an embodiment.

FIG. 3 is a side view of the battery shown in FIG. 2.

FIG. 4 is a cross-sectional view of the secondary battery according to the embodiment, taken perpendicularly to an extending direction of a terminal.

FIG. 5 is an enlarged cross-sectional view of the portion A shown in FIG. 4.

FIG. 6 is an exploded perspective view of a battery pack according to an embodiment.

FIG. 7 is a block diagram showing an electric circuit of the battery pack shown in FIG. 6.

FIG. 8 is a schematic view showing an example of a vehicle equipped with the secondary battery of the embodiment.

FIG. 9 is a diagram schematically showing another example of the vehicle according to the embodiment.

### DETAILED DESCRIPTION

In general, according to one embodiment, a slurry composition includes an active material, a conductive agent, a resin material, and a solvent comprising water. The active material includes niobium titanium-containing composite oxide particles. In a volume-based cumulative frequency distribution of particle sizes based on a particle size distribution of the slurry composition according to a laser diffraction-scattering method, a peak is positioned within a range of 0.8 μm to 3 μm, and a percentage of cumulative frequency up to a particle size of 1 μm from a smaller particle size is in a range of 20% to 35%.

According to another embodiment, there is provided a method of manufacturing an electrode. The method includes:

applying the slurry composition onto a current collector;

drying the slurry composition applied onto the current collector, thereby forming an active material-containing layer on the current collector; and

pressing the active material-containing layer.

According to another embodiment, there is provided an electrode. The electrode includes an active material-containing layer and a current collector on which the active material-containing layer is formed. The active material-containing layer includes an active material, a conductive agent, and a resin material. And the active material includes niobium titanium-containing composite oxide particles. In a volume-based cumulative frequency distribution of particle sizes based on a particle size distribution of the active material-containing layer according to a laser diffraction-scattering method, a peak is positioned within a range of 0.8 μm to 3 μm, and a percentage of cumulative frequency up to a particle size of 1 μm from a smaller particle size is in a range of 20% to 35%.

### First Embodiment

According to a first embodiment, there is provided a slurry composition that includes an active material including niobium titanium-containing composite oxide particles, a conductive agent, a resin material, and a solvent including water. In a volume-based cumulative frequency distribution of particle sizes based on a particle size distribution of the slurry composition according to a laser diffraction-scattering method, a peak is positioned within a range of 0.8 μm to 3 μm, and a percentage of cumulative frequency up to a particle size of 1 μm from a smaller particle size is in a range of 20% to 35%. The particle size distribution of the slurry composition is a unimodal distribution in which the peak is positioned close to fine particles. This particle size distribution reflects at least the particle size of the niobium titanium-containing composite oxide particles and the particle size of the conductive agent, more specifically reflects the particle size of primary particles or secondary particles of the niobium titanium-containing composite oxide, the particle size of the conductive agent, the particle size of an agglomerate including the niobium titanium-containing composite oxide and the conductive agent, and the like.

The peak position in the cumulative frequency distribution is set in a range of 0.8 μm to 3 μm for the following reasons. When the peak is at a position beyond 3 μm, agglomeration of the niobium titanium-containing composite oxide particles or the conductive agent has occurred and thus the dispersibility of the slurry composition is low. Accordingly, such incidences as an insufficient conduction path between the niobium titanium-containing composite oxide particles in an active material-containing layer of the electrode, maldistribution of a resin material such as a binder, and the like occur, resulting in an increase in the resistance of the electrode and a decrease in the life performance of a secondary battery. When the peak is at a position below 0.8 μm, damage to each component, such as breakage or cracking of the niobium titanium-containing composite oxide particles and splitting or breakage of the conductive agent, has occurred. Therefore, the resistance of the electrode increases and the life performance of the secondary battery decreases. The peak is more preferably positioned within a range of 0.9 Um to 2 μm.

The percentage of the cumulative frequency up to a particle size of 1 μm from a smaller particle size in the cumulative frequency distribution is set in a range of 20% to 35% for the following reasons. When the percentage is beyond 35%, the slurry composition contains many fine particles and is in an excessively dispersed state, and each component is damaged. On the other hand, when the percentage is below 20%, the slurry composition contains few fine particles and the dispersibility of the slurry composition is insufficient, causing generation of many agglomerates of the niobium titanium-containing composite oxide particles or the conductive agent.

When the slurry composition satisfies the above-described cumulative frequency distribution, each component is appropriately dispersed in the slurry composition, and there are few chances of occurrence of cracking of the niobium titanium-containing composite oxide particles or a decrease in the crystallinity, leading to reduction of the damage to the materials such as splitting of the conductive agent. Thus, with the slurry composition described above, an electrode having low electron resistance and low ion-conduction resistance, and a secondary battery achieving both long life and high input-output performance can be provided.

The slurry composition preferably has a cumulative frequency distribution in which a percentage of cumulative frequency up to a particle size of 2 μm from a smaller particle size is in a range of 50% to 70%. Thereby, optimization of the proportion of fine particles in the slurry composition, reduction of the damage to the material components, and suppression of agglomeration of the niobium titanium-containing composite oxide particles or the conductive agent are more likely to be achieved, and the life performance and the input-output performance of the electrode and the secondary battery can be further enhanced.

Also, the slurry composition preferably has a cumulative frequency distribution in which a percentage of cumulative frequency up to a particle size of 5 μm from a smaller particle size is in a range of 80% to 95%. Thereby, optimization of the proportion of fine particles in the slurry composition, reduction of the damage to the material components, and suppression of agglomeration of the niobium titanium-containing composite oxide particles or the conductive agent are more likely to be achieved, and the life performance and the input-output performance of the electrode and the secondary battery can be further enhanced.

The viscosity of the slurry composition at 25° C. at 100 rpm measured by a B-type viscometer is preferably in a range of 1.5 Pa·s to 5 Pa·s. When the viscosity is low, precipitation of the particles may occur in the slurry composition. Drying unevenness is also likely to occur in the drying step in the manufacture of the electrode, which results in maldistribution of a resin material such as a binder in the active material-containing layer. This may become a factor for an increase in the battery resistance and a decrease in the battery life. On the other hand, when the viscosity is high, it may be difficult to apply the slurry composition onto the current collector, or a pipe of an applicator may be clogged.

Each component included in the slurry composition will be described.

The niobium titanium-containing composite oxide particles may be in any form, such as in the form of discrete primary particles, secondary particles formed of agglomerated primary particles, or a mixture of primary particles and secondary particles.

The average particle size of the niobium titanium-containing composite oxide particles may be in a range of 0.5 μm to 3 μm.

The crystal structure of the niobium titanium-containing composite oxide particles may be, for example, orthorhombic or monoclinic.

Examples of the orthorhombic titanium-containing composite oxide include compounds represented by Li₂₊ₐM(I)_{2-b}Ti_{6-c}M(II)_{d}O_{14+σ}. Herein, M(I) is at least one selected from the group consisting of Sr, Ba, Ca, Mg, Na, Cs, Rb and K. M(II) is at least one selected from the group consisting of Zr, Sn, V, Nb, Ta, Mo, W, Y, Fe, Co, Cr, Mn, Ni and Al. The respective subscripts in the composition formula are specified as follows: 0≤a≤6, 0≤b<2, 0≤c<6, 0≤d<6, −0.5≤σ≤0.5. A specific example of the orthorhombic titanium-containing composite oxide is Li₂₊ₐNa₂Ti₆O₁₄ (0≤a≤6).

Examples of the monoclinic niobium titanium composite oxide include compounds represented by LiₓTi_{1-y}M1_{y}Nb_{2-z}M2_{z}O_{7+δ}. Herein, M1 is at least one selected from the group consisting of Zr, Si, and Sn. M2 is at least one selected from the group consisting of V, Ta, and Bi. The respective subscripts in the composition formula are specified as follows: 0≤x≤5, 0≤y<1, 0≤z<2, and −0.3≤δ≤0.3. A specific example of the monoclinic niobium titanium composite oxide is LiₓNb₂TiO₇ (0≤x≤5).

Other examples of the monoclinic niobium titanium composite oxide include compounds represented by LiₓTi_{1-y}M3_{y+z}Nb_{2-z}O_{7-δ}. Herein, M3 is at least one selected from the group consisting of Mg, Fe, Ni, Co, W, Ta, and Mo. The respective subscripts in the composition formula are specified as follows: 0≤x≤5, 0≤y<1, 0≤z<2, and −0.3≤δ≤0.3.

At least a part of the surface of the niobium titanium-containing composite oxide particles may be covered with a conductive material. Examples of the conductive material include a carbon coating and an electron-conductive inorganic material coating.

The niobium titanium-containing composite oxide particles function as an active material. The slurry composition may contain an active material other than a niobium titanium-containing composite oxide. Examples of other active materials include lithium titanate having a ramsdellite structure (e.g., Li_{2+y}Ti₃O₇, 0≤y≤3), lithium titanate having a spinel structure (e.g., Li₄₊ₓTi₅O₁₂, 0≤x≤3), titanium dioxide (TiO₂), anatase-type titanium dioxide, rutile-type titanium dioxide, and a hollandite-type titanium composite oxide. The content of the niobium titanium-containing composite oxide particles in the active material may be set in a range of 50% by mass to 100% by mass.

The content of the active material in the slurry composition may be set in a range of 68% by mass to 96% by mass.

A conductive agent is added to improve current collecting performance and to suppress contact resistance between an active material, such as a niobium titanium composite oxide, and a current collector. Examples of the conductive agent include a fibrous carbon material and a granular carbon material. Examples of the fibrous carbon material include vapor grown carbon fiber (VGCF) and carbon nanotubes. Examples of the granular carbon material include carbon black, such as acetylene black, and flake- or scale-shaped graphite. One of these may be used as the conductive agent, or two or more of these may be used in combination as the conductive agent. Alternatively, instead of using a conductive agent, a carbon coating or an electron-conductive inorganic material coating may be applied to the surface of the active material particles.

The content of the conductive agent in the slurry composition may be set in a range of 1 part by mass to 20 parts by mass with respect to 100 parts by mass of the active material.

A resin material may be a binder, a viscosity adjuster, a dispersant, or a combination of two or more of these.

The binder is added to fill gaps among the dispersed active material and to bind the active material with the current collector. Examples of the binder include polytetrafluoro ethylene (PTFE), polyvinylidene fluoride (PVdF), fluorine rubber, styrene-butadiene rubber, a polyacrylic compound, and an imide compound. One of these may be used as the binder, or two or more of these may be used in combination as the binder.

The viscosity adjuster imparts viscosity to the slurry composition. Examples of the viscosity adjuster include carboxymethyl cellulose (CMC) and a salt of CMC. One of these may be used as the viscosity adjuster, or two or more of these may be used in combination as the viscosity adjuster.

The dispersant improves the dispersibility of the conductive agent. Examples of the dispersant include polyvinylpyrrolidone (PVP), polyvinyl alcohol (PVA), polyvinyl butyral (PVB), polyvinyl chloride (PVC), dodecylbenzenesulfonic acid sodium salt, dodecylsulfonic acid sodium salt, and cellulose nanofibers. One of these may be used as the dispersant, or two or more of these may be used in combination as the dispersant.

The content of the resin material in the slurry composition may be set in a range of 1 part by mass to 10 parts by mass with respect to 100 parts by mass of the active material.

For example, water can be used as the solvent including water.

The slurry composition may further include lithium ion conductive inorganic solid particles. Examples of the lithium ion conductive inorganic solid particles include as a lithium ion conductive inorganic solid electrolyte a lithium ion conductive oxide-based solid electrolyte or a lithium ion conductive sulfide-based solid electrolyte. A lithium phosphoric acid solid electrolyte having a NASICON-type structure may be used as the lithium ion conductive oxide-based solid electrolyte. Examples of the lithium phosphoric acid solid electrolyte having a NASICON-type structure include solid electrolytes represented by a general formula Li₁₊ₓM₂(P_{1-y}M′_{y}O₄)₃ (where M and M′ are one, or two or more selected from the group consisting of Ti, Ge, Sr, Zr, Sn, Si and Al; and x is 0≤x≤0.5, and y is 0≤y≤0.2), and solid electrolytes represented by Li_{1+x+y}Alₓ(Ti,Ge)₂₋ₓSi_{y}P_{3-y}O₁₂ (0<x≤2, 0≤y<3). Examples of the lithium phosphoric acid solid electrolytes having a NASICON-type structure include LATP (Li₁₊ₓAlₓTi₂₋ₓ(PO₄)₃ (x is 0≤x≤0.5)), Li₁₊ₓAlₓZr₂₋ₓ(PO₄)₃ (x is 0≤x≤0.5), and Li₁₊ₓAlₓGe₂₋ₓ(PO₄)₃ (x is 0≤x≤0.5). LATP may have some of its elements substituted by one or two or more selected from the group consisting of Ge, Sr, Zr, Sn and Si, or may be made partially amorphous.

Amorphous LIPON (Li_{2.9}PO_{3.3}N_{0.46}) or LLZ (Li₇La₃Zr₂O₁₂) having a garnet-type structure may be used as the lithium ion conductive oxide-based solid electrolyte.

The content of the lithium ion conductive inorganic solid particles in the slurry composition may be set in a range of 0 parts by mass to 20 parts by mass with respect to 100 parts by mass of the active material.

The slurry composition is prepared by, for example, stirring the active material, the conductive agent, and the resin material together with the solvent. A target cumulative frequency distribution can be obtained by, for example, adjusting the order of adding the materials, the solid content ratio, the stirring rate, the stirring time, etc., of the composition. The niobium titanium-containing composite oxide particles and the lithium ion conductive inorganic solid particles have low conductivity. Thus, when using a fibrous carbon material as the conductive agent, the niobium titanium-containing composite oxide particles and the viscosity adjuster are added to a water solvent having the fibrous carbon material dispersed therein, and a first stirring step of stirring them is performed, whereby the surface of the niobium titanium-containing composite oxide particles can be covered with the fibrous carbon material. As such, a fibrous carbon material can be used for a conductive path between the niobium titanium-containing composite oxide particles. When using the lithium ion conductive inorganic solid particles, the niobium titanium-containing composite oxide particles, the lithium ion conductive inorganic solid particles, and the viscosity adjuster are added to a water solvent having the fibrous carbon material dispersed therein, and a second stirring step of stirring them is performed, whereby the fibrous carbon material can be used for a conductive path between the niobium titanium-containing composite oxide particles, a conductive path between the lithium ion conductive inorganic solid particles, and a conductive path between these two types of particles. After the first stirring or the second stirring are performed, a binder, and a granular carbon material as necessary, may be added to the obtained mixture, followed by a third stirring step of further stirring them. Kneading may be performed in the stirring steps.

The slurry composition need not necessarily be prepared by the process of adding the conductive agent in two stages as described above. The slurry composition may be prepared by, for example, mixing and kneading the active material, the conductive agent, and the resin material in the presence of the solvent and in the state of high solid content ratio, then adding the solvent to the resultant mixture to decrease the solid content ratio, and stirring them in the low solid content ratio.

Stirring or kneading the slurry composition in the state of high solid content ratio of the slurry composition can efficiently disperse the agglomerates of the materials. Stirring or kneading the slurry composition in the state of low solid content ratio of the slurry composition can further reduce the damage to the materials.

To achieve both suppression of agglomeration of the materials and suppression of damage to the materials, not only the solid content ratio but also the number of rotations and the stirring time of a stirring apparatus for stirring the slurry composition (e.g., a planetary centrifugal mixer) need to be taken into consideration.

A target cumulative frequency distribution can be obtained by taking into comprehensive consideration, for example, the mixing proportion of the materials, the order of adding the materials, the solid content ratio, and the number of rotations and stirring time of a stirring apparatus.

The particle size distribution of the slurry composition is measured according to a laser diffraction-scattering method. As examples of a particle size distribution measurement apparatus, MicrotracMT3000 and MicrotracMT3000II manufactured by MicrotracBEL Corp. can be cited. The measurement is performed after the slurry is put in the apparatus up to a concentration that allows for the measurement and irradiated with an ultrasound wave at 30 W for 60 seconds. Performing ultrasonic irradiation causes the slurry to be dispersed in the water solvent, allowing for disintegration of the agglomerates of the conductive agent particles and the active material particles.

Measurement of the viscosity of the slurry composition using a B-type viscometer is performed by the following method. As an example of the B-type viscometer, a TVB-10 viscometer manufactured by TOKI SANGYO can be cited. The slurry composition is put in a container having specified dimensions, and an H6 rotor is placed in the container so as to be immersed up to a specified depth. With the temperature of the slurry composition maintained at 25° C. and temperature calibration having been performed on the viscometer by an appropriate method, the number of rotations of the rotor is gradually increased from 5 rpm to 100 rpm, to measure the viscosity.

The slurry composition of the first embodiment described above includes niobium titanium-containing composite oxide particles, a conductive agent, a resin material, and water, and in a volume-based cumulative frequency distribution of particle sizes based on a particle size distribution of the slurry composition according to a laser diffraction-scattering method, a peak is positioned within a range of 0.8 μm to 3 μm, and a percentage of cumulative frequency up to a particle size of 1 μm from a smaller particle size is in a range of 20% to 35%. Thus, an electrode and a secondary battery which achieve both long life and high input-output performance can be realized.

### Second Embodiment

An electrode of a second embodiment may include a current collector and an active material-containing layer. The active material-containing layer may be formed on either one side or both sides of the current collector. The side of the current collector on which the active material-containing layer is formed is preferably a side of the current collector that crosses the thickness direction (e.g., a main surface of the current collector). The active material-containing layer includes an active material including niobium titanium-containing composite oxide particles, a conductive agent, and a resin material. In a volume-based cumulative frequency distribution of particle sizes based on a particle size distribution of the active material-containing layer according to a laser diffraction-scattering method, a peak is positioned within a range of 0.8 μm to 3 μm, and a percentage of cumulative frequency up to a particle size of 1 μm from a smaller particle size is in a range of 20% to 35%. The particle size distribution of the active material-containing layer is a unimodal distribution in which the peak is positioned close to fine particles.

The peak position in the cumulative frequency distribution is set in a range of 0.8 μm to 3 μm for the following reason. When the peak is at a position beyond 3 μm, agglomeration of the niobium titanium-containing composite oxide particles or the conductive agent has occurred in the active material-containing layer. Accordingly, such incidences as an insufficient conduction path between the niobium titanium-containing composite oxide particles in the active material-containing layer of the electrode, maldistribution of the resin material such as a binder, and the like cause an increase in the resistance of the electrode and a decrease in the life performance of a secondary battery. When the peak is at a position below 0.8 μm, damage to each component, such as breakage or cracking of the niobium titanium-containing composite oxide particles and splitting or breakage of the conductive agent, has occurred. Therefore, the resistance of the electrode increases and the life performance of the secondary battery decreases. The peak is more preferably positioned within a range of 0.9 μm to 2 μm.

The percentage of the cumulative frequency up to a particle size of 1 μm from a smaller particle size in the cumulative frequency distribution is set in a range of 20% to 35% for the following reason. When the percentage is beyond 35%, the active material-containing layer contains many fine particles, that is, is in an excessively dispersed state, causing damage to each component. On the other hand, when the percentage is below 20%, the active material-containing layer contains few fine particles, causing generation of many agglomerates of the niobium titanium-containing composite oxide particles or the conductive agent in the active material-containing layer.

When the active material-containing layer satisfies the above-described cumulative frequency distribution, each component is appropriately dispersed in the active material-containing layer, and there are few chances of occurrence of cracking of the niobium titanium-containing composite oxide particles or a decrease in the crystallinity, leading to reduction of the damage to the materials such as breakage of the conductive agent. Since the electron resistance and the ion-conduction resistance of the electrode can be reduced, a secondary battery achieving both long life and high input-output performance can be provided.

The active material-containing layer preferably has a cumulative frequency distribution in which a percentage of cumulative frequency up to a particle size of 2 μm from a smaller particle size is in a range of 50% to 70%. Thereby, optimization of the proportion of fine particles in the active material-containing layer, reduction of the damage to the material components, and suppression of agglomeration of the niobium titanium-containing composite oxide particles or the conductive agent are more likely to be achieved, and the life performance and the input-output performance of the electrode and the secondary battery can be further enhanced.

Also, the active material-containing layer preferably has a cumulative frequency distribution in which a percentage of cumulative frequency up to a particle size of 5 μm from a smaller particle size is in a range of 80% to 95%. Thereby, optimization of the proportion of fine particles in the active material-containing layer, reduction of the damage to the material components, and suppression of agglomeration of the niobium titanium-containing composite oxide particles or the conductive agent are more likely to be achieved, and the life performance and the input-output performance of the electrode and the secondary battery can be further enhanced.

The components included in the active material-containing layer may be the same as those described in the first embodiment.

The content of the active material in the active material-containing layer may be set in a range of 68% by mass to 96% by mass.

The content of the conductive agent in the active material-containing layer may be set in a range of 1 part by mass to 20 parts by mass with respect to 100 parts by mass of the active material.

The content of the resin material in the active material-containing layer may be set in a range of 1 part by mass to 10 parts by mass with respect to 100 parts by mass of the active material.

The content of lithium ion conductive inorganic solid particles in the active material-containing layer may be set in a range of 0 parts by mass to 20 parts by mass with respect to 100 parts by mass of the active material.

The current collector uses a material that is electrochemically stable at the electric potential at which lithium (Li) is inserted into and extracted from the active material. The current collector is, for example, copper, nickel, stainless steel, aluminum, or an aluminum alloy including at least one element selected from Mg, Ti, Zn, Mn, Fe, Cu and Si. The thickness of the current collector is preferably from 5 μm to 20 μm. The current collector having such a thickness can maintain a balance between the strength of the electrode and the reduction in weight.

The current collector may also include a portion that does not have the active material-containing layer formed on its surface. This portion can serve as a current collecting tab.

For example, the electrode can be produced by the following method. The slurry composition of the first embodiment is applied onto either one or both sides of the current collector. The applicator may be, for example, a slit coater. The applied slurry is then dried to obtain a stack of the active material-containing layer and the current collector. Thereafter, the stack is pressed. In this manner, the electrode is produced. The electrode may be cut, as necessary, so that it has a predetermined shape or predetermined dimensions. The electrode may be cut, for example, after drying or after pressing, or both after drying and after pressing.

The particle size distribution of the active material-containing layer is measured according to a laser diffraction-scattering method. As examples of a particle size distribution measurement apparatus, Microtrac MT3000 and Microtrac MT3000II manufactured by MicrotracBEL Corp. can be cited. The measurement is performed after the active material-containing layer scraped from the current collector using a spatula or the like is put in the apparatus up to a concentration that allows for the measurement and irradiated with an ultrasound wave at 30 W for 60 seconds. Performing ultrasonic irradiation causes the active material-containing layer to be dispersed in the water solvent, allowing for disintegration of the agglomerates of the conductive agent particles and the active material particles.

A method of extracting an electrode from a battery will be described as follows. A battery is disassembled in a glovebox filled with argon, and an electrode group is removed therefrom. A nonaqueous electrolyte in the electrode group may be removed by washing and vacuum-drying the electrode group. An electrode is removed from the electrode group to perform the above-described particle size distribution measurement.

According to the electrode of the second embodiment described above, in a volume-based cumulative frequency distribution of particle sizes based on a particle size distribution of the active material-containing layer including niobium titanium-containing composite oxide particles, a conductive agent, and a resin material according to a laser diffraction-scattering method, a peak is positioned within a range of 0.8 μm to 3 μm, and a percentage of cumulative frequency up to a particle size of 1 μm from a smaller particle size is in a range of 20% to 35%. Thus, both long life and high input-output performance can be achieved.

### Third Embodiment

According to a third embodiment, a secondary battery including a positive electrode, a negative electrode, and a nonaqueous electrolyte is provided. The electrode of the second embodiment may be used as at least one of the positive electrode or the negative electrode.

An example of a secondary battery which uses the electrode of the second embodiment as the negative electrode will be described below. The secondary battery of the embodiment includes a positive electrode, a negative electrode, and a nonaqueous electrolyte, and may also include a separator and a container member. Hereinafter, each configuration will be described.

1) Positive Electrode

The positive electrode may include a positive electrode current collector and a positive electrode active material-containing layer. The positive electrode active material-containing layer may be formed on either one or both sides of the positive electrode current collector. The positive electrode active material-containing layer may include a positive electrode active material, and optionally a conductive agent and a binder.

For example, an oxide or a sulfide may be used as a positive electrode active material. The positive electrode may include, as a positive electrode active material, one kind of compound alone, or two or more kinds of compounds in combination. Examples of the oxide and sulfide include compounds capable of having Li or Li ions inserted thereinto and extracted therefrom.

Examples of such compounds include manganese dioxide (MnO₂), iron oxide, copper oxide, nickel oxide, lithium manganese composite oxide (e.g., LiₓMn₂O₄ or LiₓMnO₂; 0<x≤1), lithium nickel composite oxide (e.g., LiₓNiO₂; 0<x≤1), lithium cobalt composite oxide (e.g., LiₓCoO₂; 0<x≤1), lithium nickel cobalt composite oxide (e.g., LiₓNi_{1+y}CO_{y}O₂; 0<x≤1, 0<y<1), lithium manganese cobalt composite oxide (e.g., LiₓMn_{y}Co_{1-y}O₂; 0<x≤1, 0<y<1), lithium manganese nickel composite oxide having a spinel structure (e.g., LiₓMn_{2-y}Ni_{y}O₄; 0<x≤1, 0<y<2), lithium phosphorus oxide having an olivine structure (e.g., LiₓFePO₄; 0<x≤1, LiₓFe_{1-y}Mn_{y}PO₄; 0<x≤1, 0<y≤1, LiₓCoPO₄; 0<x≤1), ferrous sulfate (Fe₂(SO₄)₃), vanadium oxide (e.g., V₂O₅), and lithium nickel cobalt manganese composite oxide (LiₓNi_{1-y-z}Co_{y}Mn_{z}O₂; 0<x≤1, 0<y<1, 0<z<1, y+z<1).

Among the above compounds, the following compounds are more preferably employed as a positive electrode active material: lithium manganese composite oxide having a spinel structure (e.g., LiₓMn₂O₄; 0<x≤1); lithium nickel composite oxide (e.g., LiₓNiO₂; 0<x≤1); lithium cobalt composite oxide (e.g., LiₓCoO₂; 0<x≤1); lithium nickel cobalt composite oxide (e.g., LiₓNi_{1-y}Co_{y}O₂; 0<x≤1, 0<y<1); lithium manganese nickel composite oxide having a spinel structure (e.g., LiₓMn_{2-y}Ni_{y}O₄; 0<x≤1, 0<y<2); lithium manganese cobalt composite oxide (e.g., LiₓMn_{y}Co_{1-y}O₂; 0<x≤1, 0<y<1); lithium iron phosphate (e.g., LiₓFePO₄; 0<x≤1); and lithium nickel cobalt manganese composite oxide (LiₓNi_{1-y-z}Co_{y}Mn_{z}O₂; 0<x≤1, 0<y<1, 0<z<1, y+z<1). Employing these compounds as a positive electrode active material can increase a positive electrode potential.

A lithium nickel cobalt manganese composite oxide and a lithium manganese composite oxide having a spinel structure contribute to improvement of the output performance.

The primary particle size of the positive electrode active material is preferably from 100 nm to 1 μm. A positive electrode active material having a primary particle size of 100 nm or more is easy to handle during industrial production. A positive electrode active material having a primary particle size of 1 μm or less enables diffusion of lithium ions in a solid to proceed smoothly.

The positive electrode active material preferably has a specific surface area of 0.1 m²/g to 10 m²/g. A positive electrode active material having a specific surface area of 0.1 m²/g or more can secure sufficient sites for inserting and extracting Li ions. A positive electrode active material having a specific surface area of 10 m²/g or less is easy to handle during industrial production, and can ensure good charge-and-discharge cycle performance.

The binder is added to fill gaps among the dispersed positive electrode active material and to bind the positive electrode active material with the positive current collector. Examples of the binder include polytetrafluoro ethylene (PTFE), polyvinylidene fluoride (PVdF), fluorine rubber, a polyacrylic compound, an imide compound, carboxymethyl cellulose (CMC), and a salt of CMC. One of these may be used as a binder, or two or more of these may be used in combination as the binder.

The conductive agent is added to improve current collecting performance and to suppress contact resistance between the positive electrode active material and the positive electrode current collector. Examples of the conductive agent include carbonaceous materials such as vapor grown carbon fiber (VGCF), carbon black such as acetylene black, and graphite. One of these may be used as a conductive agent, or two or more of these may be used in combination as a conductive agent. The conductive agent may be omitted.

The positive electrode active material-containing layer preferably contains the positive electrode active material and the binder in proportions of 80% by mass to 98% by mass, and 2% by mass to 20% by mass, respectively.

When the amount of the binder is 2% by mass or more, sufficient electrode strength can be obtained. The binder may serve as an insulator. Thus, setting the amount of the binder to 20% by mass or less reduces an amount of an insulator included in the electrode, allowing for reduction of the internal resistance.

When the conductive agent is added, the positive electrode active material, the binder, and the conductive agent are preferably blended in proportions of 77% by mass to 95% by mass, 2% by mass to 20% by mass, and 3% by mass to 15% by mass, respectively.

By setting the amount of the conductive agent to 3% by mass or more, the above-described effects can be exhibited. By setting the amount of the conductive agent to 15% by mass or less, the proportion of the conductive agent that comes into contact with an electrolyte can be reduced. When said proportion is low, decomposition of an electrolyte can be reduced during storage under high temperature.

The positive electrode current collector is preferably an aluminum foil, or an aluminum alloy foil including at least one element selected from Mg, Ti, Zn, Ni, Cr, Mn, Fe, Cu and Si.

The thickness of the aluminum foil or aluminum alloy foil is preferably from 5 μm to 20 μm, and more preferably 15 μm or less. The purity of the aluminum foil is preferably 99% by mass or more. The amount of transition metal such as iron, copper, nickel and chromium contained in the aluminum foil or the aluminum alloy foil is preferably 1% by mass or less.

The positive electrode current collector may also include a portion that does not have the positive electrode active material-containing layer formed on its surface. This portion can serve as a positive electrode current collecting tab.

To produce the positive electrode, for example, a positive electrode active material, a conductive agent, and a binder are suspended in a solvent to prepare a slurry. The slurry is applied to either one or both sides of the current collector. The applied slurry is then dried to obtain a stack of the active material-containing layer and the current collector. Thereafter, the stack is pressed. In this manner, the positive electrode is produced. Alternatively, the positive electrode may be produced by the following method. First, the active material, the conductive agent, and the binder are mixed to obtain a mixture. The mixture is then formed into pellets. These pellets are then arranged on the current collector, whereby the positive electrode can be obtained.

2) Nonaqueous Electrolyte

For example, a liquid nonaqueous electrolyte or a gel nonaqueous electrolyte may be used as a nonaqueous electrolyte. The liquid nonaqueous electrolyte is prepared by dissolving an electrolyte salt as a solute in an organic solvent. The concentration of the electrolyte salt is preferably 0.5 mol/L to 2.5 mol/L.

Examples of the electrolyte salt include lithium salts such as lithium perchlorate (LiClO₄), lithium hexafluorophosphate (LiPF₆), lithium tetrafluoroborate (LiBF₄), hexafluoro arsenic lithium (LiAsF₆), lithium trifluoromethanesulfonate (LiCF₃SO₃), and bistrifluoromethylsulfonylimide lithium (LiN(CF₃SO₂)₂), and mixtures thereof. As the electrolyte salt, a compound less likely to be oxidized even at a high potential is preferably employed, and LiPF₆ is most preferably employed.

Examples of the organic solvent include: cyclic carbonates such as propylene carbonate (PC), ethylene carbonate (EC), and vinylene carbonate (VC); chain carbonates such as diethyl carbonate (DEC), dimethyl carbonate (DMC), and methyl ethyl carbonate (MEC); cyclic ethers such as tetrahydrofuran (THF), 2-methyl tetrahydrofuran (2-MeTHF), and dioxolane (DOX); chain ethers such as dimethoxy ethane (DME) and diethoxy ethane (DEE); γ-butyrolactone (GBL); acetonitrile (AN); and sulfolane (SL). These organic solvents may be used alone or in the form of a mixed solvent.

The gel nonaqueous electrolyte is prepared by combining a liquid nonaqueous electrolyte and a polymeric material. Examples of the polymeric material include polyvinylidene fluoride (PVdF), polyacrylonitrile (PAN), polyethylene oxide (PEO), and mixtures thereof.

A room temperature molten salt (ionic melt) containing lithium ions, a polymer solid electrolyte, an inorganic solid electrolyte, or the like may be used as a nonaqueous electrolyte. These nonaqueous electrolyte may be used alone, or mixed each other, or mixed with the liquid nonaqueous electrolyte or the gel nonaqueous electrolyte.

The room temperature molten salt (ionic melt) refers to compounds which may exist in a liquid state at normal temperature (15° C. to 25° C.), among organic salts formed of combinations of organic cations and anions. The room temperature molten salt includes those that exist alone in a liquid state, those that turn into a liquid state when mixed with an electrolyte salt, those that turn into a liquid state when dissolved in an organic solvent, and mixtures thereof. A room temperature molten salt used in a secondary battery generally has a melting point of 25° C. or less. Organic cations generally have a quaternary ammonium framework.

The polymer solid electrolyte is prepared by dissolving an electrolyte salt in a polymeric material and solidifying them.

The inorganic solid electrolyte is a solid substance having Li ion conductivity.

3) Separator

The separator may be made of, for example, a porous film or a synthetic resin nonwoven fabric including polyethylene (PE), polypropylene (PP), cellulose, or polyvinylidene fluoride (PVdF). In view of safety, a porous film made of polyethylene or polypropylene is preferably used. This is because such a porous film melts at a fixed temperature and thus is able to shut off current.

4) Container Member

For example, a container made of a laminated film or a metallic container may be used as a container member.

The thickness of the laminated film is, for example, 0.5 mm or less, and preferably 0.2 mm or less.

A multilayer film including multiple resin layers and a metal layer interposed between the resin layers is used as a laminated film. The resin layers each include a polymeric material such as polypropylene (PP), polyethylene (PE), nylon, or polyethylene terephthalate (PET). The metal layer is preferably made of an aluminum foil or an aluminum alloy foil to reduce weight. The laminated film may be formed into the shape of the container member by heat-sealing.

The wall thickness of the metallic container is, for example, 1 mm or less, more preferably 0.5 mm or less, and still more preferably 0.2 mm or less.

For example, the metallic container is made of aluminum or an aluminum alloy. The aluminum alloy preferably contains an element such as magnesium, zinc, or silicon. If the aluminum alloy contains transition metal such as iron, copper, nickel, or chromium, the content thereof is preferably 100 ppm by mass or less.

The shape of the container member is not particularly limited. The shape of the container member may be, for example, flat (thin), prismatic, cylindrical, coin-shaped, button-shaped, or the like. The container member may be appropriately selected depending on the size of the battery and the use of the battery.

An example of the secondary battery of the embodiment will be described with reference to FIGS. 2 to 5.

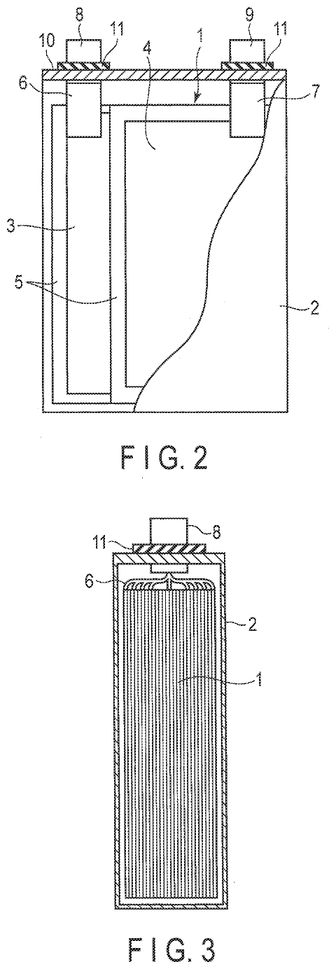

FIGS. 2 and 3 illustrate an example of a secondary battery which uses a metallic container.

An electrode group 1 is housed in a metallic container 2 having a rectangular tubular shape. The electrode group 1 is formed by, for example, interposing a separator 5 between a positive electrode 3 and a negative electrode 4 and winding the stack of the positive electrode 3, the separator 5 and the negative electrode 4 into a flat spiral shape about an axis parallel to the short-side direction of the stack. As shown in FIG. 3, strip-shaped positive electrode leads 6 are electrically connected to multiple portions of an end of the positive electrode 3, respectively, that is positioned on an end face of the electrode group 1 that crosses the stacking direction of the electrode. Strip-shaped negative electrode leads 7 are also electrically connected to multiple portions of an end of the negative electrode 4, respectively, that is positioned on said end face of the electrode group 1. A bundle of positive electrode leads 6 is electrically connected to a positive electrode current collecting tab 8. A positive electrode terminal is formed of the positive electrode leads 6 and the positive electrode current collecting tab 8. A bundle of negative electrode leads 7 are connected to a negative electrode current collecting tab 9. A negative electrode terminal is formed of the negative electrode leads 7 and the negative electrode current collecting tab 9. A sealing plate 10 made of metal is fixed to an opening of the metallic container 2 by welding or the like. The positive electrode current collecting tab 8 and the negative electrode current collecting tab 9 are respectively drawn out from outlet holes provided in the sealing plate 10. The inner peripheral surface of each outlet hole of the sealing plate 10 is coated with an insulating member 11 in order to prevent a short circuit from occurring due to a contact between the positive electrode current collecting tab 8 and the negative electrode current collecting tab 9.

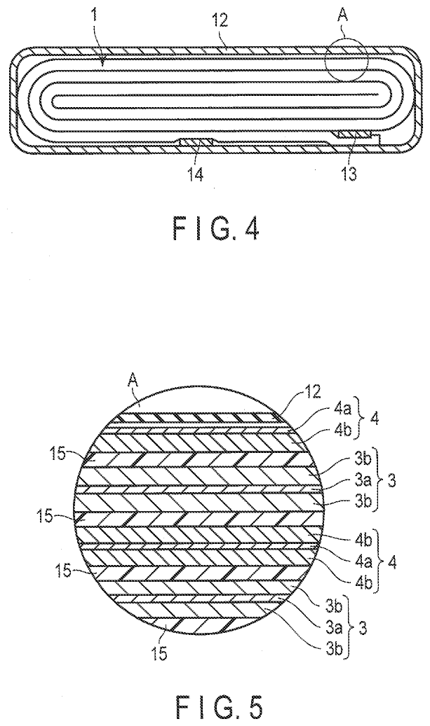

FIGS. 4 and 5 illustrate an example of a secondary battery which uses a container member made of a laminated film.

As shown in FIGS. 4 and 5, a flat wound electrode group 1 is housed in a bag-form container member 12 made of a laminated film including two resin films and a metal layer interposed therebetween. The flat wound electrode group 1 is formed by spirally winding a stack obtained by stacking a negative electrode 4, a separator 15, a positive electrode 3, and a separator 15 in the mentioned order from the outer side, about an axis parallel to the short-side direction of the stack, and then press-forming the wound stack. The portion of the negative electrode 4 at the outermost layer has a structure in which a negative electrode layer (negative electrode active material-containing layer) 4b containing a negative electrode active material is formed on one side of a negative electrode current collector 4a that is on the internal surface side, as shown in FIG. 5; and the other portions of the negative electrode 4 have a structure in which the negative electrode layer 4b is formed on both sides of the negative electrode current collector 4a. The positive electrode 3 is configured so that a positive electrode layer (positive electrode active material-containing layer) 3b is formed on both sides of a positive electrode current collector 3a.

In the vicinity of the outer peripheral edge of the wound electrode group 1, a negative electrode terminal 13 is connected to the negative electrode current collector 4a of the negative electrode 4 at the outermost layer, and a positive electrode terminal 14 is connected to the positive electrode current collector 3a of the positive electrode 3 on the inner side. The negative electrode terminal 13 and the positive electrode terminal 14 are extended out from an opening of the bag-form container member 12. The opening of the bag-form container member 12 is heat-sealed, thereby sealing the wound electrode group 1. When heat-sealing the opening of the bag-form container member 12, the negative electrode terminal 13 and the positive electrode terminal 14 are held by the bag-form container member 12 at the opening thereof.

The secondary battery of the third embodiment described above includes the electrode of the second embodiment as a negative electrode, and thus can improve life performance and input-output performance.

### Fourth Embodiment

A battery pack according to a fourth embodiment may include one or more of the secondary batteries (unit cells) according to the third embodiment. A plurality of secondary batteries may be electrically connected in series, in parallel, or in a combination of in-series connection and in-parallel connection, to constitute a battery module. The battery pack according to the embodiment may include a plurality of battery modules.

The battery pack according to the embodiment may further include a protective circuit. The protective circuit functions to control charge and discharge of the secondary battery. Alternatively, a circuit included in devices (such as electronic devices and automobiles) which use a battery pack as a power source may be used as the protective circuit of the battery pack.

The battery pack according to the embodiment may further include an external power distribution terminal. The external power distribution terminal is configured to output current from the secondary battery to the outside and to input current into the secondary battery. In other words, when using the battery pack as a power source, current is supplied to the outside through the external power distribution terminal. When charging the battery pack, charge current (including regenerative energy of motive force of vehicles such as automobiles) is supplied to the battery pack through the external power distribution terminal.

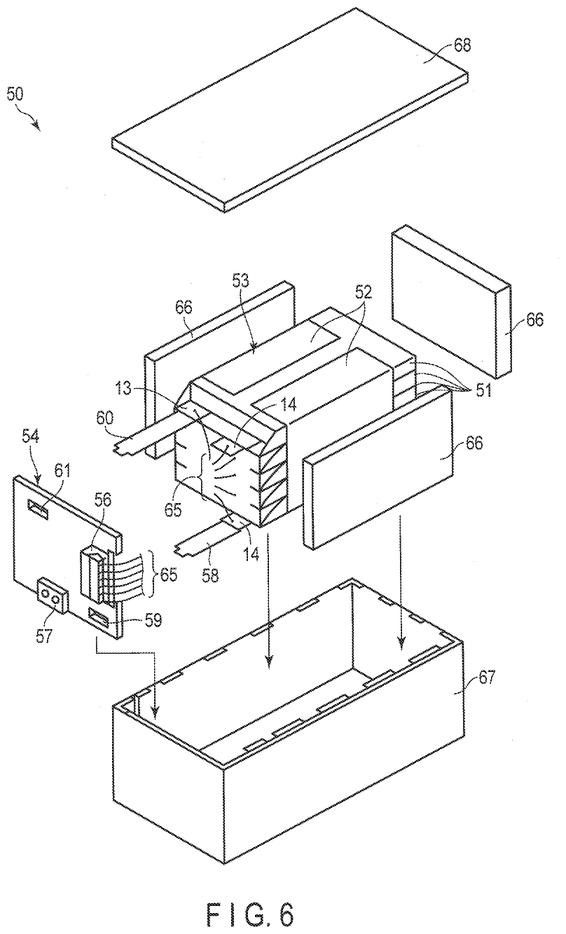

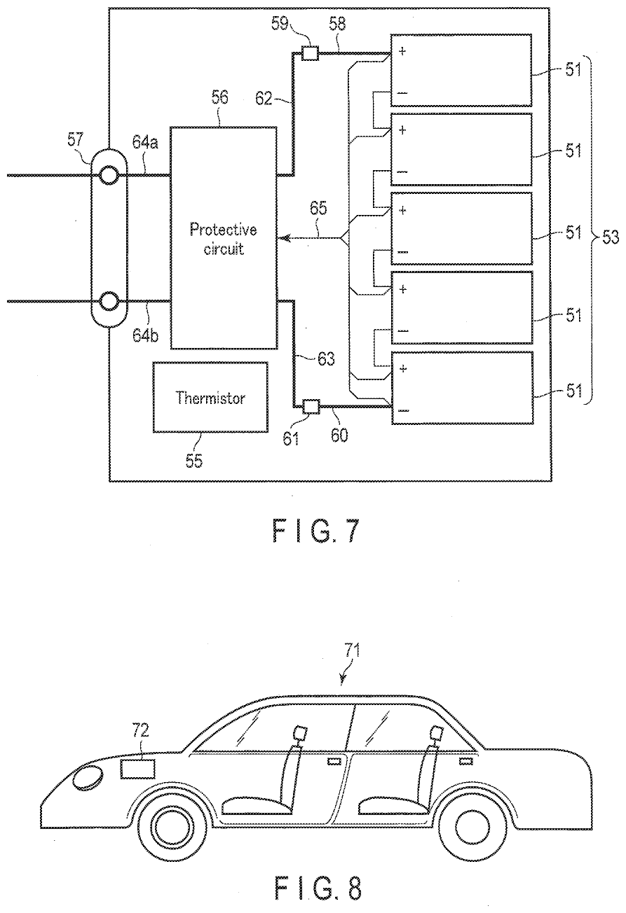

FIGS. 6 and 7 show an example of a battery pack 50. The battery pack 50 includes a plurality of flat batteries having the structure shown in FIG. 6. FIG. 6 is an exploded perspective view of the battery pack 50. FIG. 7 is a block diagram showing an electric circuit of the battery pack 50 shown in FIG. 6.

A plurality of unit cells 51 are stacked such that the negative electrode terminal 13 and positive electrode terminal 14 extending outward are aligned in the same direction, and are fastened with an adhesive tape 52, to thereby constitute a battery module 53. These unit cells 51 are electrically connected to each other in series, as shown in FIG. 7.

A printed wiring board 54 is arranged to face the side surface of the unit cell 51 from which the negative electrode terminal 13 and the positive electrode terminal 14 extend. A thermistor 55, a protective circuit 56, and an external power distribution terminal 57 to an external device are mounted on the printed wiring board 54, as shown in FIG. 7. An insulating plate (not shown) is attached to the surface of the printed wiring board 54 that faces the battery module 53 in order to avoid unnecessary connection with the wires of the battery module 53.

A positive electrode-side lead 58 is connected to the positive electrode terminal 14 positioned at the bottom layer of the battery module 53 and the distal end of the positive electrode-side lead 58 is inserted into a positive electrode-side connector 59 of the printed wiring board 54 so as to be electrically connected thereto. A negative electrode-side lead 60 is connected to the negative electrode terminal 13 positioned at the top layer of the battery module 53 and the distal end of the negative electrode-side lead 60 is inserted into a negative electrode-side connector 61 of the printed wiring board 54 so as to be electrically connected thereto. The connectors 59 and 61 are connected to the protective circuit 56 through wires 62 and 63 formed on the printed wiring board 54.

The thermistor 55 detects the temperature of the unit cells 51, so that the detection signals are transmitted to the protective circuit 56. The protective circuit 56 can shut off a plus-side wire 64a and a minus-side wire 64b between the protective circuit 56 and the external power distribution terminal 57 to an external device under predetermined conditions. The predetermined conditions refer to, for example, a case where the temperature detected by the thermistor 55 reaches a predetermined temperature or higher. The predetermined conditions also refer to a case where overcharge, overdischarge, over-current, or the like of the unit cells 51 is detected. The detection of the overcharge or the like is performed for the individual unit cells 51 or the unit cells 51 as a whole. In the case of detecting the individual unit cells 51, a battery voltage may be detected, or a positive electrode potential or a negative electrode potential may be detected. In the latter case, a lithium electrode used as a reference electrode is inserted into each unit cell 51. In the instance shown in FIGS. 6 and 7, a wire 65 for voltage detection is connected to each of the unit cells 51, and detection signals are sent to the protective circuit 56 through the wire 65.

Protective sheets 66 made of rubber or resin are arranged on three side surfaces of the battery module 53 except the side surface from which the positive electrode terminal 14 and the negative electrode terminal 13 protrude.

The battery module 53 is housed in the housing container 67 together with each protective sheet 66 and the printed wiring board 54. Specifically, the protective sheets 66 are arranged on both of the inner side surfaces in the long-side direction and an inner side surface in the short-side direction of the housing container 67, respectively, and the printed wiring board 54 is arranged on the inner side surface on the opposite side in the short-side direction. The battery module 53 is in a space surrounded with the protective sheets 66 and the printed wiring board 54. A lid 68 is attached to an upper surface of the housing container 67.

In order to fix the battery module 53, a heat-shrinkable tape may be used instead of an adhesive tape 52. In this case, the protective sheets are placed on both of the side surfaces of the battery module, and the heat-shrinkable tape is wound around the battery module and then thermally shrunk, to thereby bind the battery module.

FIGS. 6 and 7 show the configuration in which the unit cells 51 are connected in series; however, the unit cells 51 may be connected in parallel to increase the battery capacity. Alternatively, the unit cells 51 may be connected in a combination of in-series connection and in-parallel connection. Assembled battery packs may also be connected in series or in parallel.

The battery pack shown in FIGS. 6 and 7 includes a single battery module; however, the battery pack according to the embodiment may include a plurality of battery modules. The plurality of battery modules are electrically connected in series, in parallel, or in a combination of in-series connection and in-parallel connection.

The aspect of the battery pack can be appropriately changed depending on the application. The battery pack according to the embodiment is suitably used in applications where excellent cycle performance is demanded when a large current is extracted. Specifically, the battery pack is used as a power source of a digital camera, a battery of a vehicle such as a two- or four-wheeled hybrid electric automobile, a two- or four-wheeled electric automobile, an electric bicycle, or a railway vehicle (such as an electric train), or a stationary battery. In particular, the battery pack is suitably used as an in-vehicle battery for vehicles.

The battery pack of the fourth embodiment described above includes the secondary battery of the embodiment, and thus can achieve both excellent life performance and excellent input-output performance.

### Fifth Embodiment

A vehicle of a fifth embodiment includes one or two or more of the secondary batteries of the embodiment, or includes the battery pack of the embodiment.

In a vehicle, such as an automobile, equipped with the battery pack according to the fifth embodiment, it is preferable that the battery pack, for example, recover regenerative energy of the motive force of the vehicle. The vehicle may include a mechanism configured to convert kinetic energy of the vehicle into regenerative energy.

FIG. 8 shows an example of an automobile equipped with an example battery pack according to the embodiment.

The automobile 71 shown in FIG. 8 is equipped with an example battery pack 72 according to the embodiment in the engine compartment in a front part of the automobile. The place where the battery pack is installed in the automobile is not limited to the engine compartment. For example, the battery pack may be installed in a rear part of the automobile or under a seat.

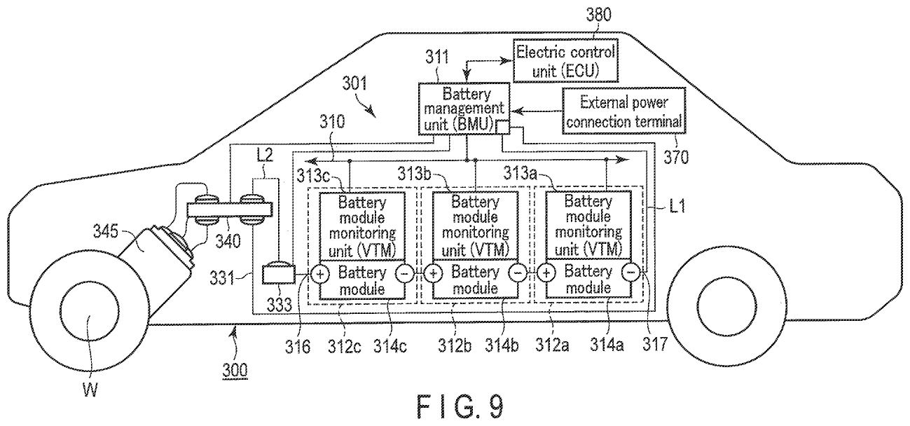

FIG. 9 is a diagram schematically showing a configuration of an example of the vehicle according to the embodiment. A vehicle 300 shown in FIG. 9 is an electric automobile.

The vehicle 300 shown in FIG. 9 includes a vehicle power source 301, a vehicle electric control unit (ECU) 380, which is a master controller of the vehicle power source 301, an external terminal 370, an inverter 340, and a drive motor 345.

The vehicle 300 includes the vehicle power source 301 in the engine compartment, in a rear part of the automobile, or under a seat, for example. FIG. 9, however, schematically shows an installing position of the secondary battery in the vehicle 300.

The vehicle power source 301 includes a plurality of (e.g., three) battery packs 312a, 312b and 312c, a battery management unit (BMU) 311, and a communication bus 310.

The three battery packs 312a, 312b and 312c are electrically connected in series. The battery pack 312a includes a battery module 314a and a voltage temperature monitor (VTM) 313a. The battery pack 312b includes a battery module 314b and a voltage temperature monitor 313b. The battery pack 312c includes a battery module 314c and a voltage temperature monitor 313c. The battery packs 312a, 312b and 312c are removable independently of each other, and each can be replaced with a different battery pack.

Each of the battery modules 314a to 314c includes a plurality of secondary batteries connected in series. Each of the secondary batteries is the secondary battery according to the embodiment. The battery modules 314a to 314c each perform charging and discharging via a positive electrode terminal 316 and a negative electrode terminal 317.

To collect information related to maintenance of the vehicle power source 301, the battery management unit 311 communicates with the voltage temperature monitors 313a to 313c and collects information on the voltage, temperature, and the like of the secondary batteries of the battery modules 314a to 314c included in the vehicle power source 301.

The battery management unit 311 and the voltage temperature monitors 313a to 313c are connected via the communication bus 310. The communication bus 310 is configured to share a set of communication wires with a plurality of nodes (battery management unit and at least one voltage temperature monitor). The communication bus 310 is, for example, a communication bus configured in accordance with the controller area network (CAN) standard.

The voltage temperature monitors 313a to 313c measure a voltage and a temperature of individual secondary batteries constituting the battery modules 314a to 314c based on commands received from the battery management unit 311 through communication. The temperature may be measured only at several points per battery module, and it is not necessary to measure the temperatures of all the secondary batteries.

The vehicle power source 301 may also include an electromagnetic contactor (such as a switch unit 333 shown in FIG. 9) configured to switch on and off a connection between the positive electrode terminal and the negative electrode terminal. The switch unit 333 includes a pre-charge switch (not shown) which turns on when the battery modules 314a to 314c are charged, and a main switch (not shown) which turns on when the output from the battery is supplied to a load. The pre-charge switch and the main switch each include a relay circuit (not shown) configured to turn on and off in accordance with a signal supplied to a coil near a switching element.

The inverter 340 converts an input direct current voltage to a three-phase alternate current (AC) high voltage for driving a motor. The output voltage from the inverter 340 is controlled based on a control signal from the battery management unit 311 or the vehicle ECU 380 configured to control the entire operation of the vehicle. Three-phase output terminals of the inverter 340 are respectively connected to three-phase input terminals of the drive motor 345.

The drive motor 345 is rotated by electric power supplied from the inverter 340, and transmits the rotation to axles and drive wheels W via, for example, a differential gear unit.

The vehicle 300 also includes a regenerative brake mechanism (not shown) configured to rotate the drive motor 345 when the vehicle 300 is braked, and convert kinetic energy into regenerative energy as electric energy. The regenerative energy recovered in the regenerative brake mechanism is input to the inverter 340 and converted into a direct current. The direct current is input to the vehicle power source 301.

One of the terminals of a connection line L1 is connected to the negative electrode terminal 317 of the vehicle power source 301 via a current detector (not shown) included in the battery management unit 311. The other of the terminals of the connection line L1 is connected to a negative electrode input terminal of the inverter 340.

One of the terminals of a connection line L2 is connected to the positive electrode terminal 316 of the vehicle power source 301 via the switch unit 333. The other of the terminals of the connection line L2 is connected to a positive electrode input terminal of the inverter 340.

The external terminal 370 is connected to the battery management unit 311, which will be described later. The external terminal 370 can be connected to, for example, an external power source.

The vehicle ECU 380 controls the battery management unit 311 cooperatively with other apparatuses in response to operation input from a driver, etc., and thereby manages the entire vehicle. Data related to maintenance of the vehicle power source 301, such as a remaining capacity of the vehicle power source 301, is transferred between the battery management unit 311 and the vehicle ECU 380 through a communication line.

The vehicle according to the embodiment includes battery packs which include the secondary battery according to the embodiment, and the battery packs (e.g., battery packs 312a, 312b and 312c) have excellent life performance and excellent input-output performance. Thus, a vehicle excellent in charge-and-discharge performance and high in reliability can be obtained. In addition, the battery packs are inexpensive and highly safe, and thus can suppress the costs of the vehicle and enhance the safety of the vehicle.

### EXAMPLES

Hereinafter, examples of the present invention will be described in detail with reference to the accompanying drawings, but the embodiments of the present invention are not limited to the examples shown below.

### Example 1

(Production of Slurry Composition)

Carbon fibers were dispersed in pure water to prepare a carbon fiber-dispersed solution. Carbon nanotubes were used as carbon fibers. The carbon fiber-dispersed solution, an active material, lithium ion conductive inorganic solid particles, and a viscosity adjuster were mixed together, and the resulting mixture was stirred using a planetary centrifugal mixer (Awatori Rentaro) manufactured by THINKY CORPORATION, to prepare a first slurry. Table 2 shows the solid content ratio, the stirring rate (number of rotations), and the stirring time of the first slurry. Particles of a niobium titanium composite oxide (Nb₂TiO₇) having an average particle size of about 1 μm were used as an active material. Carboxymethyl cellulose (CMC) was used as a viscosity adjuster. Lithium phosphoric acid solid electrolyte particles (Li_{1+x+y}Alₓ(Ti,Ge)₂₋ₓSi_{y}P_{3-y}O₁₂ (0<x≤2, 0≤y<3)) having a NASICON-type structure and having an average particle size of 0.5 μm and lithium ion conductivity of 1×10⁻⁴ S/cm were used as lithium ion conductive inorganic solid particles.

The first slurry was mixed with granular carbon and a binder, and the resulting mixture was stirred using a planetary centrifugal mixer, to prepare a second slurry. At this time, the solid content ratio of the second slurry was 60% by mass. The stirring was conducted at a stirring rate of 1500 rpm for a stirring time of 2 minutes. Acetylene black (AB) having an average particle size of 0.2 μm was used as granular carbon. Styrene-butadiene rubber was used as a binder. In the second slurry, the amounts of the inorganic solid particles, the carbon fibers, the granular carbon, the viscosity adjuster, and the binder were 4 parts by mass, 3 parts by mass, 3 parts by mass, 2 parts by mass, and 3 parts by mass, respectively, with respect to 100 parts by mass of the active material.

The second slurry was mixed with pure water so that the solid content ratio was 49% by mass, and further stirring was conducted using a planetary centrifugal mixer, to prepare a third slurry. The stirring of the third slurry was conducted at a stirring rate of 1000 rpm for a stirring time of 1 minute.

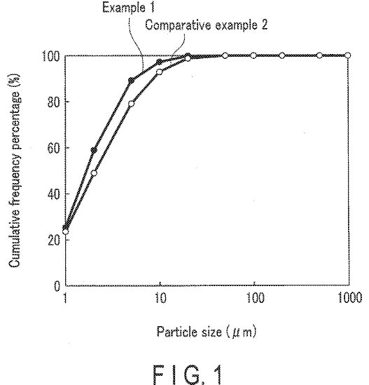

FIG. 1 shows a volume-based cumulative frequency distribution of particle sizes (μm) based on a particle size distribution of the slurry composition according to a laser diffraction-scattering method measured by the above-described method. The horizontal axis of FIG. 1 represents a logarithmic scale (log) of particle sizes (μm), and the vertical axis of FIG. 1 represents a percentage (%) of cumulative frequency of particle sizes (μm) based on volume. Table 1 shows a peak position, a percentage of cumulative frequency up to a particle size of 1 μm from a smaller particle size, a percentage of cumulative frequency up to a particle size of 2 μm from a smaller particle size, and a percentage of cumulative frequency up to a particle size of 5 μm from a smaller particle size, in the cumulative frequency distribution.

Table 1 also shows the result of the viscosity of the slurry composition at 25° C. at 100 rpm measured using a B-type viscometer by the method described above.

(Production of Negative Electrode)

The above slurry composition was applied onto both sides of a current collector and the coating was dried, to form an active material-containing layer. An aluminum foil having a thickness of 12 μm was used as a current collector. After the active material-containing layer was dried at 130° C. for 12 hours in vacuum, both the active material-containing layer and the current collector were roll-pressed by a roll-press machine to obtain a negative electrode. The density of the active material-containing layer after pressing was 2.5 g/cm³.

When a volume-based cumulative frequency distribution of particle sizes (μm) based on a particle size distribution of the active material-containing layer of the negative electrode according to a laser diffraction-scattering method measured by the above-described method was created, a cumulative frequency distribution having the same profile as that shown in FIG. 1 was obtained.

### Examples 2 to 11 and Comparative Examples 1 to 4

A slurry composition was prepared in the same manner as described in Example 1, except that the solid content ratio, the stirring rate, and the stirring time of each of the first slurry, the second slurry, and the third slurry were set to the values shown in Table 2. An electrode was produced in the same manner as described in Example 1 by using the slurry composition thus prepared. Table 1 shows a peak position, a percentage of cumulative frequency up to a particle size of 1 μm from a smaller particle size, a percentage of cumulative frequency up to a particle size of 2 μm from a smaller particle size, and a percentage of cumulative frequency up to a particle size of 5 μm from a smaller particle size, in the cumulative frequency distribution of each of the slurry compositions and the electrodes of the Examples and the Comparative Examples. Table 1 also shows the B-type viscosity of each of the slurry compositions. FIG. 1 also shows a cumulative frequency distribution of the slurry composition of Comparative Example 2.

(Evaluation of Input-Output Performance)

A three-electrode glass cell was produced and the input-output performance thereof was evaluated. The electrodes had a square shape with a side length of 2 cm. Lithium metal was used for a counter electrode and a reference electrode. A solution obtained by dissolving lithium hexafluorophosphate (LiPF₆) in a mixed solvent of ethylene carbonate and diethyl carbonate was used as a nonaqueous electrolyte. The volume ratio of ethylene carbonate and diethyl carbonate in the mixed solvent was 1:2. The concentration of LiPF₆ was 1 mol/L. The amount of the nonaqueous electrolyte was 25 mL.

First, the three-electrode glass cell thus produced was charged at 25° C. at a current density of 1 C until the state of charge (SOC) reached 100%. Then, the cell was discharged at a current density of 0.2 C until the SOC became 0%, and a discharge capacity W1 was measured. Next, the three-electrode glass cell was charged again at a current density of 1 C until the SOC reached 100%. Then, the cell was discharged at a current density of 5 C until the SOC became 0%, and a discharge capacity W2 was measured. A capacity ratio W2/W1 was calculated by dividing the discharge capacity W2 by the discharge capacity W1. Table 3 shows the capacity ratio W2/W1.

<Evaluation of Cycle Performance>

The cycle performance was evaluated using the three-electrode glass cell. The cell was charged at 25° C. at a current density of 1 C until the SOC reached 100%. Then, the cell was discharged at a current density of 1 C until the SOC became 0%, and a discharge capacity was measured. The above-described charge and discharge as one cycle were repeated until the discharge capacity retention became 80% with respect to the first discharge capacity. Table 3 shows the number of charge-and-discharge cycles.

TABLE 1

| | | Cumulative | Cumulative | Cumulative | |
|---|---|---|---|---|---|
| | | frequency | frequency | frequency | B-Type |
| | Peak | percentage | percentage | percentage | viscosity |
| | position | (%) up to 1 μm | (%) up to 2 μm | (%) up to 5 μm | 100 rpm |
| | (μm) | particle size | particle size | particle size | (Pa · S) |
| Example 1 | 1.5 | 26 | 56 | 89 | 3.5 |
| Example 2 | 0.8 | 33 | 67 | 92 | 1.6 |
| Example 3 | 3 | 22 | 53 | 84 | 4.1 |
| Example 4 | 2.7 | 20 | 55 | 88 | 3.7 |
| Example 5 | 0.9 | 35 | 65 | 93 | 2 |
| Example 6 | 2.8 | 21 | 50 | 82 | 4.3 |
| Example 7 | 0.9 | 34 | 70 | 94 | 1.8 |
| Example 8 | 2.5 | 24 | 54 | 80 | 3.6 |
| Example 9 | 1.3 | 23 | 68 | 95 | 2.2 |
| Example 10 | 1 | 32 | 66 | 90 | 1.5 |
| Example 11 | 2.8 | 24 | 55 | 85 | 5 |
| Comparative | 0.7 | 33 | 72 | 96 | 1.6 |
| Example 1 | | | | | |
| Comparative | 3.2 | 20 | 49 | 81 | 3.1 |
| Example 2 | | | | | |
| Comparative | 2.9 | 19 | 48 | 83 | 4.4 |
| Example 3 | | | | | |
| Comparative | 0.9 | 37 | 73 | 96 | 1.3 |
| Example 4 | | | | | |

TABLE 2

| | First | | | Second | | | Third | | |
|---|---|---|---|---|---|---|---|---|---|
| | slurry | First | First | slurry | Second | Second | slurry | Third | Third |
| | Solid | slurry | slurry | Solid | slurry | slurry | Solid | slurry | slurry |
| | content | Stirring | Stirring | content | Stirring | Stirring | content | Stirring | Stirring |
| | ratio | rate | time | ratio | rate | time | ratio | rate | time |
| | (Mass %) | (rpm) | (min) | (Mass %) | (rpm) | (min) | (Mass %) | (rpm) | (min) |
| Example 1 | 7 | 1500 | 1 | 60 | 1500 | 2 | 49 | 1000 | 1 |
| Example 2 | 8 | 1500 | 1 | 60 | 2000 | 4 | 49 | 1000 | 1 |
| Example 3 | 8 | 1500 | 1 | 60 | 1500 | 0.5 | 49 | 1000 | 1 |
| Example 4 | 6 | 1500 | 1 | 55 | 1500 | 1 | 50 | 1000 | 1 |
| Example 5 | 8 | 1500 | 1 | 65 | 1500 | 5 | 50 | 1000 | 1 |
| Example 6 | 7 | 1500 | 1 | 58 | 1500 | 1 | 46 | 1000 | 2 |
| Example 7 | 8 | 1500 | 1 | 63 | 1500 | 5 | 55 | 3000 | 1 |
| Example 8 | 7 | 1500 | 1 | 56 | 1500 | 1 | 49 | 1000 | 2 |
| Example 9 | 6 | 1500 | 1 | 60 | 1500 | 4 | 48 | 1000 | 0.5 |
| Example 10 | 8 | 1500 | 1 | 58 | 2000 | 3 | 46 | 1000 | 0.5 |
| Example 11 | 8 | 1500 | 1 | 56 | 1500 | 1 | 50 | 1000 | 2 |
| Comparative | 5 | 2000 | 2 | 60 | 2000 | 6 | 50 | 1000 | 2 |
| Example 1 | | | | | | | | | |
| Comparative | 7 | 1500 | 1 | 51 | 1500 | 0.5 | 49 | 1000 | 1 |
| Example 2 | | | | | | | | | |
| Comparative | 6 | 1500 | 0.5 | 55 | 1500 | 1 | 47 | 1000 | 2 |
| Example 3 | | | | | | | | | |
| Comparative | 7 | 1500 | 1 | 63 | 2000 | 5 | 49 | 1000 | 1 |
| Example 4 | | | | | | | | | |

TABLE 3

| | Capacity | Charge-and-discharge |
|---|---|---|
| | ratio | cycle life |
| | W2/W1 | (Number of cycles) |
| Example 1 | 0.72 | 3000 |
| Example 2 | 0.75 | 3000 |
| Example 3 | 0.64 | 2700 |
| Example 4 | 0.69 | 2700 |
| Example 5 | 0.71 | 2500 |
| Example 6 | 0.68 | 2800 |
| Example 7 | 0.7 | 2400 |
| Example 8 | 0.68 | 2800 |
| Example 9 | 0.7 | 3100 |
| Example 10 | 0.73 | 2500 |
| Example 11 | 0.69 | 2200 |
| Comparative | 0.52 | 700 |
| Example 1 | | |
| Comparative | 0.39 | 600 |
| Example 2 | | |
| Comparative | 0.4 | 700 |
| Example 3 | | |
| Comparative | 0.5 | 700 |
| Example 4 | | |

As is apparent from Tables 1 to 3, Examples 1 to 11 were excellent in the input-output performance represented by the capacity ratio W2/W1 and in the cycle life performance, as compared to Comparative Examples 1 to 4. FIG. 1 compares the cumulative frequency distribution of the slurry composition of Example 1 and the cumulative frequency distribution of the slurry composition of Comparative Example 2. As is apparent from FIG. 1, the slurry composition of Example 1 had a proportion of the volumes of the fine particles among the total volume of all the particles larger than that of Comparative Example 2.

Comparative Example 1 had a peak at a position below 0.8 μm in the cumulative frequency distribution. This was due to the damage, such as breakage or cracking of the niobium titanium-containing composite oxide particles or disconnection or breakage of the conductive agent, caused by the high stirring rate and the long stirring time of the first slurry and the second slurry.

Comparative Example 2 had a peak at a position beyond 3 μm in the cumulative frequency distribution. This was due to the agglomeration of the niobium titanium-containing composite oxide particles or the conductive agent caused by stirring the second slurry in a state of low solid content ratio.

Comparative Example 3 had a percentage of cumulative frequency up to a particle size of 1 μm that was below 20%. This was due to the agglomeration of the niobium titanium-containing composite oxide particles or the conductive agent caused by the short stirring time of the first slurry.

Comparative Example 4 had a percentage of cumulative frequency up to a particle size of 1 μm that was beyond 35%. This was due to the damage, such as breakage or cracking of the niobium titanium-containing composite oxide particles or disconnection or breakage of the conductive agent, caused by the high stirring rate and the long stirring time of the second slurry.

### Example 12

(Production of Slurry Composition)

The same carbon fibers as those described in Example 1 were dispersed in pure water to prepare a carbon fiber-dispersed solution. The carbon fiber-dispersed solution, an active material, lithium ion conductive inorganic solid particles, and a viscosity adjuster were mixed together, and the resulting mixture was stirred using a planetary centrifugal mixer (Awatori Rentaro) manufactured by THINKY CORPORATION, to prepare a first slurry. Table 5 shows the solid content ratio, the stirring rate (number of rotations), and the stirring time of the first slurry. The same active material, viscosity adjuster, and lithium ion conductive inorganic solid particles as those described in Example 1 were used.

The first slurry was mixed with granular carbon and a binder, and the resulting mixture was stirred using a planetary centrifugal mixer, to prepare a second slurry. Table 5 shows the solid content ratio, the stirring rate, and the stirring time of the second slurry. A scale-shaped graphite having an average particle size of 3 μm was used as granular carbon. The same binder as that described in Example 1 was used. In the second slurry, the amounts of the inorganic solid particles, the carbon fibers, the granular carbon, the viscosity adjuster, and the binder were 5 parts by mass, 3 parts by mass, 3 parts by mass, 2 parts by mass, and 4 parts by mass, respectively, with respect to 100 parts by mass of the active material.

The second slurry was mixed with pure water so that the solid content ratio had the value shown in Table 5, and further stirring was conducted using a planetary centrifugal mixer, to prepare a third slurry. Table 5 shows the stirring rate and the stirring time. A volume-based cumulative frequency distribution of particle sizes (μm) was created from a particle size distribution of the slurry composition according to a laser diffraction-scattering method measured by the above-described method. Table 4 shows the peak position, the percentage of cumulative frequency up to a particle size of 1 μm from a smaller particle size, the percentage of cumulative frequency up to a particle size of 2 μm from a smaller particle size, and the percentage of cumulative frequency up to a particle size of 5 μm from a smaller particle size, in the cumulative frequency distribution. Table 4 also shows the B-type viscosity of the slurry composition.

(Production of Negative Electrode)

The above slurry composition was used to obtain a negative electrode by the same method as described in Example 1. The density of the active material-containing layer after pressing was 2.5 g/cm³.

When a volume-based cumulative frequency distribution of particle sizes (μm) based on a particle size distribution of the active material-containing layer of the negative electrode according to a laser diffraction-scattering method measured by the above-described method, was created, a cumulative frequency distribution having the same profile as that shown in the case of the slurry composition was obtained.

Table 6 shows the result of the input-output performance and the cycle performance measured using the obtained negative electrode of Example 12 in the same manner as described in Example 1.

### Example 13

Particles of a niobium titanium-containing composite oxide (TiNb_{1.9}Mo_{0.075}Mg_{0.025}O₇) having an average particle size of about 2 μm were used as an active material. A slurry composition was prepared in the same manner as described in Example 1, except that this active material was used and the solid content ratio, the stirring rate, and the stirring time of each of the first slurry, the second slurry, and the third slurry were set to the values shown in Table 5. A volume-based cumulative frequency distribution of particle sizes (μm) was created from a particle size distribution of the slurry composition according to a laser diffraction-scattering method measured by the above-described method. Table 4 shows the peak position, the percentage of cumulative frequency up to a particle size of 1 μm from a smaller particle size, the percentage of cumulative frequency up to a particle size of 2 μm from a smaller particle size, and the percentage of cumulative frequency up to a particle size of 5 μm from a smaller particle size, in the cumulative frequency distribution. Table 4 also shows the B-type viscosity of the slurry composition.

(Production of Negative Electrode)

The above slurry composition was used to obtain a negative electrode by the same method as described in Example 1. The density of the active material-containing layer after pressing was 2.5 g/cm³.

When a volume-based cumulative frequency distribution of particle sizes (μm) based on a particle size distribution of the active material-containing layer of the negative electrode according to a laser diffraction-scattering method measured by the above-described method, was created, a cumulative frequency distribution having the same profile as that shown in the case of the slurry composition was obtained.

Table 6 shows the result of the input-output performance and the cycle performance measured using the obtained negative electrode of Example 13 in the same manner as described in Example 1.

### Example 14

Polyvinylidene fluoride was used as a binder. A slurry composition was prepared in the same manner as described in Example 1, except that this binder was used and the solid content ratio, the stirring rate, and the stirring time of each of the first slurry, the second slurry, and the third slurry were set to the values shown in Table 5. A volume-based cumulative frequency distribution of particle sizes (μm) was created from a particle size distribution of the slurry composition according to a laser diffraction-scattering method measured by the above-described method. Table 4 shows the peak position, the percentage of cumulative frequency up to a particle size of 1 μm from a smaller particle size, the percentage of cumulative frequency up to a particle size of 2 μm from a smaller particle size, and the percentage of cumulative frequency up to a particle size of 5 μm from a smaller particle size, in the cumulative frequency distribution. Table 4 also shows the B-type viscosity of the slurry composition.

(Production of Negative Electrode)

The above slurry composition was used to obtain a negative electrode by the same method as described in Example 1. The density of the active material-containing layer after pressing was 2.5 g/cm³.

When a volume-based cumulative frequency distribution of particle sizes (μm) based on a particle size distribution of the active material-containing layer of the negative electrode according to a laser diffraction-scattering method measured by the above-described method, was created, a cumulative frequency distribution having the same profile as that shown in the case of the slurry composition was obtained.

Table 6 shows the result of the input-output performance and the cycle performance measured using the obtained negative electrode of Example 14 in the same manner as described in Example 1.

### Example 15

(Production of Slurry Composition)

Carbon fibers were dispersed in pure water to prepare a carbon fiber-dispersed solution. Vapor grown carbon fiber (VGCF) was used as carbon fibers. The carbon fiber-dispersed solution, an active material, lithium ion conductive inorganic solid particles, and a viscosity adjuster were mixed together, and the resulting mixture was stirred using a planetary centrifugal mixer (Awatori Rentaro) manufactured by THINKY CORPORATION, to prepare a first slurry. Table 5 shows the solid content ratio, the stirring rate (number of rotations), and the stirring time of the first slurry. The same active material, viscosity adjuster, and lithium ion conductive inorganic solid particles as those described in Example 1 were used. The first slurry was mixed with granular carbon and a binder, and the resulting mixture was stirred using a planetary centrifugal mixer, to prepare a second slurry. Table 5 shows the solid content ratio, the stirring rate, and the stirring time of the second slurry. The same granular carbon and binder as those described in Example 1 were used. In the second slurry, the amounts of the inorganic solid particles, the carbon fibers, the granular carbon, the viscosity adjuster, and the binder were 4 parts by mass, 2 parts by mass, 3 parts by mass, 3 parts by mass, and 3 parts by mass, respectively, with respect to 100 parts by mass of the active material.

The second slurry was mixed with pure water so that the solid content ratio had the value shown in Table 5, and further stirring was conducted using a planetary centrifugal mixer, to prepare a third slurry. Table 5 shows the stirring rate and the stirring time. A volume-based cumulative frequency distribution of particle sizes (μm) was created from a particle size distribution of the slurry composition according to a laser diffraction-scattering method measured by the above-described method. Table 4 shows the peak position, the percentage of cumulative frequency up to a particle size of 1 μm from a smaller particle size, the percentage of cumulative frequency up to a particle size of 2 μm from a smaller particle size, and the percentage of cumulative frequency up to a particle size of 5 μm from a smaller particle size, in the cumulative frequency distribution. Table 4 also shows the B-type viscosity of the slurry composition.

(Production of Negative Electrode)

The above slurry composition was used to obtain a negative electrode by the same method as described in Example 1. The density of the active material-containing layer after pressing was 2.5 g/cm³.

When a volume-based cumulative frequency distribution of particle sizes (μm) based on a particle size distribution of the active material-containing layer of the negative electrode according to a laser diffraction-scattering method measured by the above-described method, was created, a cumulative frequency distribution having the same profile as that shown in the case of the slurry composition was obtained.

Table 6 shows the result of the input-output performance and the cycle performance measured using the obtained negative electrode of Example 15 in the same manner as described in Example 1.

### Example 16

A first slurry was prepared using the same materials as those described in Example 1, except that PVP was used as a dispersant. Table 5 shows the solid content ratio, the stirring rate (number of rotations), and the stirring time of the first slurry. A second slurry and a third slurry were prepared in the same manner as described in Example 1, except that the solid content ratio, the stirring rate (number of rotations), and the stirring time were set to the values shown in Table 5. In the obtained slurry composition, the amounts of the inorganic solid particles, the carbon fibers, the granular carbon, the viscosity adjuster, the dispersant, and the binder were 4 parts by mass, 2 parts by mass, 3 parts by mass, 3 parts by mass, 1 part by mass, and 3 parts by mass, respectively, with respect to 100 parts by mass of the active material. A volume-based cumulative frequency distribution of particle sizes (μm) was created from a particle size distribution of the slurry composition according to a laser diffraction-scattering method measured by the above-described method. Table 4 shows the peak position, the percentage of cumulative frequency up to a particle size of 1 μm from a smaller particle size, the percentage of cumulative frequency up to a particle size of 2 μm from a smaller particle size, and the percentage of cumulative frequency up to a particle size of 5 μm from a smaller particle size, in the cumulative frequency distribution. Table 4 also shows the B-type viscosity of the slurry composition.

(Production of Negative Electrode)

The above slurry composition was used to obtain a negative electrode by the same method as described in Example 1. The density of the active material-containing layer after pressing was 2.5 g/cm³.

When a volume-based cumulative frequency distribution of particle sizes (μm) based on a particle size distribution of the active material-containing layer of the negative electrode according to a laser diffraction-scattering method measured by the above-described method, was created, a cumulative frequency distribution having the same profile as that shown in the case of the slurry composition was obtained.

Table 6 shows the result of the input-output performance and the cycle performance measured using the obtained negative electrode of Example 16 in the same manner as described in Example 1.

### Example 17

A first slurry was prepared using the same materials as those described in Example 1, except that PVB was used as a dispersant. Table 5 shows the solid content ratio, the stirring rate (number of rotations), and the stirring time of the first slurry. A second slurry and a third slurry were prepared in the same manner as described in Example 1, except that the solid content ratio, the stirring rate (number of rotations), and the stirring time were set to the values shown in Table 5. In the obtained slurry composition, the amounts of the inorganic solid particles, the carbon fibers, the granular carbon, the viscosity adjuster, the dispersant, and the binder were 4 parts by mass, 2 parts by mass, 3 parts by mass, 3 parts by mass, 1 part by mass, and 3 parts by mass, respectively, with respect to 100 parts by mass of the active material. A volume-based cumulative frequency distribution of particle sizes (μm) was created from a particle size distribution of the slurry composition according to a laser diffraction-scattering method measured by the above-described method. Table 4 shows the peak position, the percentage of cumulative frequency up to a particle size of 1 μm from a smaller particle size, the percentage of cumulative frequency up to a particle size of 2 μm from a smaller particle size, and the percentage of cumulative frequency up to a particle size of 5 μm from a smaller particle size, in the cumulative frequency distribution. Table 4 also shows the B-type viscosity of the slurry composition.

(Production of Negative Electrode)

The above slurry composition was used to obtain a negative electrode by the same method as described in Example 1. The density of the active material-containing layer after pressing was 2.5 g/cm³.

When a volume-based cumulative frequency distribution of particle sizes (μm) based on a particle size distribution of the active material-containing layer of the negative electrode according to a laser diffraction-scattering method measured by the above-described method, was created, a cumulative frequency distribution having the same profile as that shown in the case of the slurry composition was obtained.

Table 6 shows the result of the input-output performance and the cycle performance measured using the obtained negative electrode of Example 17 in the same manner as described in Example 1.

### Example 18

A first slurry was prepared using the same materials as those described in Example 1, except that cellulose nanofibers were used as a dispersant. Table 5 shows the solid content ratio, the stirring rate (number of rotations), and the stirring time of the first slurry. A second slurry and a third slurry were prepared in the same manner as described in Example 1, except that the solid content ratio, the stirring rate (number of rotations), and the stirring time were set to the values shown in Table 5. In the obtained slurry composition, the amounts of the inorganic solid particles, the carbon fibers, the granular carbon, the viscosity adjuster, the dispersant, and the binder were 4 parts by mass, 2 parts by mass, 3 parts by mass, 3 parts by mass, 1 part by mass, and 3 parts by mass, respectively, with respect to 100 parts by mass of the active material. A volume-based cumulative frequency distribution of particle sizes (μm) was created from a particle size distribution of the slurry composition according to a laser diffraction-scattering method measured by the above-described method. Table 4 shows the peak position, the percentage of cumulative frequency up to a particle size of 1 μm from a smaller particle size, the percentage of cumulative frequency up to a particle size of 2 μm from a smaller particle size, and the percentage of cumulative frequency up to a particle size of 5 μm from a smaller particle size, in the cumulative frequency distribution. Table 4 also shows the B-type viscosity of the slurry composition.

(Production of Negative Electrode)

The above slurry composition was used to obtain a negative electrode by the same method as described in Example 1. The density of the active material-containing layer after pressing was 2.5 g/cm³.

When a volume-based cumulative frequency distribution of particle sizes (μm) based on a particle size distribution of the active material-containing layer of the negative electrode according to a laser diffraction-scattering method measured by the above-described method, was created, a cumulative frequency distribution having the same profile as that shown in the case of the slurry composition was obtained.

Table 6 shows the result of the input-output performance and the cycle performance measured using the obtained negative electrode of Example 18 in the same manner as described in Example 1.

### Example 19

A slurry was prepared in the same manner as described in Example 1, except that PVP and cellulose nanofibers were used as a dispersant 1 and a dispersant 2, respectively. A second slurry and a third slurry were prepared in the same manner as described in Example 1, except that the solid content ratio, the stirring rate (number of rotations), and the stirring time were set to the values shown in Table 5. In the obtained slurry composition, the amounts of the inorganic solid particles, the carbon fibers, the granular carbon, the viscosity adjuster, the dispersant 1, the dispersant 2, and the binder were 4 parts by mass, 3 parts by mass, 3 parts by mass, 2 parts by mass, 1 part by mass, 1 part by mass, and 3 parts by mass, respectively, with respect to 100 parts by mass of the active material. A volume-based cumulative frequency distribution of particle sizes (μm) was created from a particle size distribution of the slurry composition according to a laser diffraction-scattering method measured by the above-described method. Table 4 shows the peak position, the percentage of cumulative frequency up to a particle size of 1 μm from a smaller particle size, the percentage of cumulative frequency up to a particle size of 2 μm from a smaller particle size, and the percentage of cumulative frequency up to a particle size of 5 μm from a smaller particle size, in the cumulative frequency distribution. Table 4 also shows the B-type viscosity of the slurry composition.

(Production of Negative Electrode)

The above slurry composition was used to obtain a negative electrode by the same method as described in Example 1. The density of the active material-containing layer after pressing was 2.5 g/cm³.

When a volume-based cumulative frequency distribution of particle sizes (μm) based on a particle size distribution of the active material-containing layer of the negative electrode according to a laser diffraction-scattering method measured by the above-described method, was created, a cumulative frequency distribution having the same profile as that shown in the case of the slurry composition was obtained.

Table 6 shows the result of the input-output performance and the cycle performance measured using the obtained negative electrode of Example 19 in the same manner as described in Example 1.

### Example 20

A slurry was prepared in the same manner as described in Example 1, except that a first slurry was prepared without using lithium ion conductive inorganic solid particles. A second slurry and a third slurry were prepared in the same manner as described in Example 1, except that the solid content ratio, the stirring rate (number of rotations), and the stirring time were set to the values shown in Table 5. In the obtained slurry composition, the amounts of the carbon fibers, the granular carbon, the viscosity adjuster, and the binder were 3 parts by mass, 3 parts by mass, 2 parts by mass, and 3 parts by mass, respectively, with respect to 100 parts by mass of the active material. A volume-based cumulative frequency distribution of particle sizes (μm) was created from a particle size distribution of the slurry composition according to a laser diffraction-scattering method measured by the above-described method. Table 4 shows the peak position, the percentage of cumulative frequency up to a particle size of 1 μm from a smaller particle size, the percentage of cumulative frequency up to a particle size of 2 μm from a smaller particle size, and the percentage of cumulative frequency up to a particle size of 5 μm from a smaller particle size, in the cumulative frequency distribution. Table 4 also shows the B-type viscosity of the slurry composition.

(Production of Negative Electrode)

The above slurry composition was used to obtain a negative electrode by the same method as described in Example 1. The density of the active material-containing layer after pressing was 2.5 g/cm³.

When a volume-based cumulative frequency distribution of particle sizes (μm) based on a particle size distribution of the active material-containing layer of the negative electrode according to a laser diffraction-scattering method measured by the above-described method, was created, a cumulative frequency distribution having the same profile as that shown in the case of the slurry composition was obtained.

Table 6 shows the result of the input-output performance and the cycle performance measured using the obtained negative electrode of Example 20 in the same manner as described in Example 1.

### Example 21

A slurry was prepared in the same manner as described in Example 1, except that acetylene black (AB) having an average particle size of 0.2 μm and scale-shaped carbon having an average particle size of 4 μm were used as granular carbon 1 and granular carbon 2, respectively. A second slurry and a third slurry were prepared in the same manner as described in Example 1, except that the solid content ratio, the stirring rate (number of rotations), and the stirring time were set to the values shown in Table 5. In the obtained slurry composition, the amounts of the inorganic solid particles, the carbon fibers, the granular carbon 1, the granular carbon 2, the viscosity adjuster, and the binder were 4 parts by mass, 3 parts by mass, 3 parts by mass, 3 parts by mass, 2 parts by mass, and 3 parts by mass, respectively, with respect to 100 parts by mass of the active material. A volume-based cumulative frequency distribution of particle sizes (μm) was created from a particle size distribution of the slurry composition according to a laser diffraction-scattering method measured by the above-described method. Table 4 shows the peak position, the percentage of cumulative frequency up to a particle size of 1 μm from a smaller particle size, the percentage of cumulative frequency up to a particle size of 2 μm from a smaller particle size, and the percentage of cumulative frequency up to a particle size of 5 μm from a smaller particle size, in the cumulative frequency distribution. Table 4 also shows the B-type viscosity of the slurry composition.

(Production of Negative Electrode)

The above slurry composition was used to obtain a negative electrode by the same method as described in Example 1. The density of the active material-containing layer after pressing was 2.5 g/cm³.

When a volume-based cumulative frequency distribution of particle sizes (μm) based on a particle size distribution of the active material-containing layer of the negative electrode according to a laser diffraction-scattering method measured by the above-described method, was created, a cumulative frequency distribution having the same profile as that shown in the case of the slurry composition was obtained.

Table 6 shows the result of the input-output performance and the cycle performance measured using the obtained negative electrode of Example 21 in the same manner as described in Example 1.

(Example 22)

Carbon fibers, an active material, lithium ion conductive inorganic solid particles, granular carbon, a dispersant, a viscosity adjuster, a binder, and water were mixed together, and the resulting mixture was stirred using a planetary centrifugal mixer (Awatori Rentaro) manufactured by THINKY CORPORATION, to prepare a first slurry. Table 5 shows the solid content ratio, the stirring rate (number of rotations), and the stirring time of the first slurry. Particles of a niobium-titanium composite oxide (Nb₂TiO₇) having an average particle size of about 1 μm were used as an active material. Carboxymethyl cellulose (CMC) was used as a viscosity adjuster. Lithium phosphoric acid solid electrolyte particles (Li_{1+x+y}Alₓ(Ti,Ge)₂₋ₓSi_{y}P_{3-y}O₁₂ (0<x≤2, 0≤y<3)) having a NASICON-type structure and having an average particle size of 0.5 μm and lithium ion conductivity of 1×10⁻⁴ S/cm were used as lithium ion conductive inorganic solid particles. PVP was used as a dispersant. Acetylene black (AB) having an average particle size of 0.2 μm was used as granular carbon. Styrene-butadiene rubber was used as a binder. In the first slurry, the amounts of the inorganic solid particles, the carbon fibers, the granular carbon, the viscosity adjuster, the dispersant, and the binder were 4 parts by mass, 3 parts by mass, 3 parts by mass, 2 parts by mass, 1 part by mass, and 3 parts by mass, respectively, with respect to 100 parts by mass of the active material.

The first slurry was mixed with pure water and further stirring was conducted using a planetary centrifugal mixer, to prepare a second slurry. Table 5 shows the solid content ratio, the stirring speed (number of rotations), and the stirring time of the second slurry. A volume-based cumulative frequency distribution of particle sizes (μm) was created from a particle size distribution of the slurry composition according to a laser diffraction-scattering method measured by the above-described method. Table 4 shows the peak position, the percentage of cumulative frequency up to a particle size of 1 μm from a smaller particle size, the percentage of cumulative frequency up to a particle size of 2 μm from a smaller particle size, and the percentage of cumulative frequency up to a particle size of 5 μm from a smaller particle size, in the cumulative frequency distribution. Table 4 also shows the B-type viscosity of the slurry composition.

(Production of Negative Electrode)

The above slurry composition was used to obtain a negative electrode by the same method as described in Example 1. The density of the active material-containing layer after pressing was 2.5 g/cm³.

When a volume-based cumulative frequency distribution of particle sizes (μm) based on a particle size distribution of the active material-containing layer of the negative electrode according to a laser diffraction-scattering method measured by the above-described method, was created, a cumulative frequency distribution having the same profile as that shown in the case of the slurry composition was obtained.

Table 6 shows the result of the input-output performance and the cycle performance measured using the obtained negative electrode of Example 22 in the same manner as described in Example 1.

TABLE 4

| | | Cumulative | Cumulative | Cumulative | |
|---|---|---|---|---|---|
| | | frequency | frequency | frequency | B-Type |
| | Peak | percentage (%) | percentage (%) | percentage (%) | viscosity |
| | position | up to 1 μm | up to 2 μm | up to 5 μm | 100 rpm |
| | (μm) | particle size | particle size | particle size | (Pa · S) |
| Example 12 | 2.1 | 22 | 56 | 86 | 3.6 |
| Example 13 | 1.5 | 25 | 56 | 92 | 3.2 |
| Example 14 | 1.3 | 26 | 60 | 93 | 2.8 |
| Example 15 | 1.8 | 23 | 58 | 83 | 3.9 |
| Example 16 | 1.4 | 27 | 55 | 91 | 3.3 |
| Example 17 | 1.5 | 28 | 55 | 90 | 3.2 |
| Example 18 | 1.4 | 28 | 54 | 91 | 3.3 |
| Example 19 | 1.5 | 29 | 58 | 90 | 3.4 |
| Example 20 | 1.5 | 25 | 54 | 87 | 3.5 |
| Example 21 | 1.3 | 28 | 60 | 92 | 3.8 |
| Example 22 | 1.2 | 30 | 62 | 92 | 3.0 |

TABLE 5

| | First | | | Second | | | Third | | |
|---|---|---|---|---|---|---|---|---|---|
| | slurry | First | First | slurry | Second | Second | slurry | Third | Third |
| | Solid | slurry | slurry | Solid | slurry | slurry | Solid | slurry | slurry |
| | content | Stirring | Stirring | content | Stirring | Stirring | content | Stirring | Stirring |
| | ratio | rate | time | ratio | rate | time | ratio | rate | time |
| | (Mass %) | (rpm) | (min) | (Mass %) | (rpm) | (min) | (Mass %) | (rpm) | (min) |
| Example 12 | 5 | 1500 | 1 | 60 | 1500 | 3 | 55 | 1000 | 1 |
| Example 13 | 7 | 1500 | 1 | 59 | 1500 | 2 | 52 | 1000 | 1 |
| Example 14 | 5 | 1500 | 1 | 64 | 1500 | 2 | 49 | 1000 | 1 |
| Example 15 | 5 | 1500 | 1 | 58 | 1500 | 3 | 49 | 1000 | 1 |
| Example 16 | 7 | 1500 | 0.5 | 60 | 1500 | 2 | 49 | 1000 | 1 |
| Example 17 | 7 | 1500 | 0.5 | 60 | 1500 | 2 | 49 | 1000 | 1 |
| Example 18 | 7 | 1500 | 0.5 | 60 | 1500 | 2 | 49 | 1000 | 1 |
| Example 13 | 7 | 1500 | 1 | 60 | 1500 | 2 | 49 | 1000 | 1 |
| Example 20 | 7 | 1500 | 1 | 60 | 1500 | 2 | 49 | 1000 | 1 |
| Example 21 | 7 | 1500 | 1 | 61 | 1500 | 2 | 49 | 1000 | 1 |
| Example 22 | 58 | 1500 | 3 | 48 | 1000 | 1 | — | — | — |

TABLE 6

| | Capacity | Charge-and-discharge |
|---|---|---|
| | ratio | cycle life |
| | W2/W1 | (Number of cycles) |
| Example 12 | 0.64 | 1900 |
| Example 13 | 0.71 | 2800 |
| Example 14 | 0.68 | 2000 |
| Example 15 | 0.76 | 3000 |
| Example 16 | 0.69 | 3000 |
| Example 17 | 0.71 | 3000 |
| Example 18 | 0.72 | 3000 |
| Example 19 | 0.74 | 3200 |
| Example 20 | 0.7 | 3000 |
| Example 21 | 0.75 | 3200 |
| Example 22 | 0.72 | 3000 |

From the results shown in Tables 4 to 6, it is understood that by satisfying a predetermined cumulative frequency distribution even when, for example, the composition of the slurry is changed by, for example, changing the type of active material, conductive agent, or binder, or the order of adding the materials is changed, an electrode and a secondary battery excellent in the input-output performance and the cycle performance can be achieved.

The slurry composition according to at least one of the embodiments or the Examples includes niobium titanium-containing composite oxide particles, a conductive agent, a resin material, and water, and in a volume-based cumulative frequency distribution of particle sizes based on a particle size distribution of the slurry composition according to a laser diffraction-scattering method, a peak is positioned within a range of 0.8 μm to 3 μm, and a percentage of cumulative frequency up to a particle size of 1 μm from a smaller particle size is in a range of 20% to 35%. Thus, an electrode and a secondary battery which achieve both long life and high input-output performance can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A slurry composition comprising: an active material; a conductive agent; a resin material; and a solvent comprising water, and the active material comprising niobium titanium-containing composite oxide particles, wherein in a volume-based cumulative frequency distribution of particle sizes based on a particle size distribution of the slurry composition according to a laser diffraction-scattering method, a peak is positioned within a range of 0.8 μm to 3 μm, and a percentage of cumulative frequency up to a particle size of 1 μm from a smaller particle size is in a range of 20% to 35%.

2. The slurry composition according to claim 1, wherein in the cumulative frequency distribution, a percentage of cumulative frequency up to a particle size of 2 μm from a smaller particle size is in a range of 50% to 70%.

3. The slurry composition according to claim 1, wherein in the cumulative frequency distribution, a percentage of cumulative frequency up to a particle size of 5 μm from a smaller particle size is in a range of 80% to 95%.

4. The slurry composition according to claim 1, wherein a viscosity of the slurry composition at 25° C. at 100 rpm measured by a B-type viscometer is in a range of 1.5 Pa·s to 5 Pa·s.

5. The slurry composition according to claim 1, further comprising lithium ion conductive inorganic solid particles.

6. The slurry composition according to claim 1, wherein the niobium titanium-containing composite oxide particles are represented by LiₓTi_{1-y}M1_{y}Nb_{2-z}M2ₓO_{7+δ} (where M1 is at least one selected from the group consisting of Zr, Si, and Sn, M2 is at least one selected from the group consisting of V, Ta, and Bi, 0≤x≤5, 0≤y<1, 0≤z<2, and −0.3≤δ≤0.3), or represented by LiₓTi_{1-y}M3_{y+z}Nb_{2-z}O_{7-δ} (where M3 is at least one selected from the group consisting of Mg, Fe, Ni, Co, W, Ta, and Mo, 0≤x≤5, 0≤y<1, 0≤z<2, and −0.3≤5≤0.3).

7. A method of manufacturing an electrode, the method comprising:
applying the slurry composition according to claim 1 onto a current collector;
drying the slurry composition applied onto the current collector, thereby forming an active material-containing layer on the current collector; and
pressing the active material-containing layer.

8. An electrode comprising: an active material-containing layer and a current collector on which the active material-containing layer is formed, the active material-containing layer comprising an active material, a conductive agent, and a resin material, and the active material comprising niobium titanium-containing composite oxide particles,
wherein in a volume-based cumulative frequency distribution of particle sizes based on a particle size distribution of the active material-containing layer according to a laser diffraction-scattering method, a peak is positioned within a range of 0.8 μm to 3 μm, and a percentage of cumulative frequency up to a particle size of 1 μm from a smaller particle size is in a range of 20% to 35%.

9. The electrode according to claim 8, wherein in the cumulative frequency distribution, a percentage of cumulative frequency up to a particle size of 2 μm from a smaller particle size is in a range of 50% to 70%.

10. The electrode according to claim 8, wherein in the cumulative frequency distribution, a percentage of cumulative frequency up to a particle size of 5 μm from a smaller particle size is in a range of 80% to 95%.

11. The electrode according to claim 8, wherein the niobium titanium-containing composite oxide particles are represented by LiₓTi_{1-y}M1_{y}Nb_{2-z}M2_{z}O_{7+δ} (where M1 is at least one selected from the group consisting of Zr, Si, and Sn, M2 is at least one selected from the group consisting of V, Ta, and Bi, 0≤x≤5, 0≤y<1, 0≤z<2, and −0.3≤δ≤0.3), or represented by LiₓTi_{1-y}M3_{y+z}Nb_{2-z}O_{7-δ} (where M3 is at least one selected from the group consisting of Mg, Fe, Ni, Co, W, Ta, and Mo, 0≤x≤5, 0≤y<1, 0≤z<2, and −0.3≤δ≤0.3).

12. A secondary battery comprising:
a positive electrode;
the electrode according to claim 8 as a negative electrode; and
a nonaqueous electrolyte.

13. A battery pack comprising one or two or more of the secondary battery according to claim 12.

14. The battery pack according to claim 13, further comprising an external power distribution terminal and
a protective circuit.

15. The battery pack according to claim 13, comprising two or more of the secondary battery, wherein the two or more secondary batteries are electrically connected in series, in parallel, or in a combination of in-series connection and in-parallel connection.

16. A vehicle comprising the battery pack according to claim 13.

17. The vehicle according to claim 16, comprising a mechanism configured to convert kinetic energy of the vehicle into regenerative energy.
